(19) United States
(12) Patent Application Publication
(10) Pub. No.: US 2015/0023643 A1
(43) Pub. Date: Jan. 22, 2015

(54) GRADIENT OPTICAL POLYMER NANOCOMPOSITES

(71) Applicant: State of Oregon acting by and through the State Board of Higher Education on behalf of the Univers, Eugene, OR (US)

(72) Inventors: Richard Chartoff, Eugene, OR (US); Casey Check, Eugene, OR (US)

(73) Assignee: State of Oregon acting by and through the State Board of Higher Education on behalf of the Univers, Eugene, OR (US)

(21) Appl. No.: 13/944,793

(22) Filed: Jul. 17, 2013

(51) Int. Cl. G02B 6/028; C08K 3/30

(52) U.S. Cl. CPC G02B 6/028; C08K 3/30; C08K 2003/3009
USPC 385/124; 524/420

(57) ABSTRACT

Gradient index optical materials are formed by drop by drop dispensing of nanoparticle/monomer suspensions. Refractive index variations are defined by nanoparticle concentrations that can vary in three dimensions. Droplets of differing compositions can be mixed, and droplets or layers or droplets are partially cross-linked by exposure to ultraviolet radiation prior to dispensing additional droplets. Gradient index optical elements such as lenses, prisms, and waveguides can be formed in flexible polymer layers.

### ACKNOWLEDGMENT OF GOVERNMENT SUPPORT

This invention was made with government support under contract FA8650-12-C-7226 awarded by the Air Force Research Laboratory. The government has certain rights in the invention.

### CROSS REFERENCE TO RELATED APPLICATION

This application is related to U.S. patent application entitled SOLUBLE FUNCTIONALIZED NANOPARTICLES FOR USE IN OPTICAL MATERIALS, filed concurrently, and which is incorporated herein by reference.

### FIELD

The disclosure pertains to optical elements formed with nanocomposites.

### BACKGROUND

Traditionally optical elements are made by grinding, polishing and other mechanical processes. Such mechanical process are generally suitable for production of certain surface shapes (spherical or planar), but more complex shapes either cannot be made or tend to be expensive. While some gradient index materials are available, these typically are not readily adaptable to making a variety desired refractive index profiles. Adaptable manufacturing methods are needed for producing arbitrary refractive index profiles without complex, expensive setups.

### SUMMARY

Optical elements comprise layers defined by a plurality of fused droplets, the droplets including a polymer containing dispersed nanoparticles such that a nanoparticle concentration defines a refractive index difference. In some examples, the layers define a sheet having first and second major surfaces that are parallel, and the refractive index varies in a plane parallel to the first and second major surfaces. In other examples, the refractive index varies in a direction perpendicular to the first and second major surfaces. In typical examples, the refractive index difference is a gradient index configured to form a lens such as a cylindrical lens, a spherical lens, or an array of such lenses.

In some embodiments, the refractive index n varies as a function n=n₀(1−Ar²/2), wherein n₀ and A are real constants, and r is a distance measured along an axis in a plane parallel to the first and second major surfaces. In some examples, the nanoparticles are PbS or ZnS nanoparticles.

Optical waveguides comprise a nanoparticle doped polymer layer, wherein the nanoparticle doping is configured to define a waveguide core. In some examples, the nanoparticle doping varies along an axis parallel to the polymer layer. In a representative embodiment, the nanoparticle doping is configured to provide a refractive index variation that defines a circular waveguide core.

Arrays of optical elements include a polymer layer. A plurality of nanoparticle-doped regions are defined in the polymer layer, and a nanoparticle concentration in each of the doped regions is configured to define a corresponding refractive index gradient, wherein each of the doped regions comprises a plurality of interdiffused polymer droplets.

Methods include establishing a target surface and defining a target surface area based on a perimeter retainer. Nanoparticle doped monomer droplets are directed toward the target surface area so as to define droplet layers having predetermined refractive index distributions, wherein one or more droplet layers are partially crosslinked prior to deposition of one or more subsequent droplet layers. In some examples, monomer droplets are applied having at least two different concentrations of nanoparticles or having at least two different nanoparticle compositions. In some examples, the monomer droplets are applied in a controlled atmosphere such as a non-oxidizing atmosphere. In representative examples, the monomer droplets are applied so as to produce a predetermined refractive index variation. In still further embodiments, the applied monomer droplet layers are exposed so as to substantially crosslink the monomer and the crosslinked droplet layers are removed from the substrate.

According to some examples, the nanoparticles are PbS or ZnS nanoparticles. In other examples, a monomer is selected and the nanoparticles are functionalized based on the selected monomer. In some embodiments, the predetermined refractive index distributions correspond to a gradient index lens or a gradient index waveguide.

The foregoing and other objects, features, and advantages of the invention will become more apparent from the following detailed description, which proceeds with reference to the accompanying figures.

### BRIEF DESCRIPTION OF THE DRAWINGS

FIG. 1 illustrates a representative system for producing optical components based on nanoparticle containing monomer droplets.

FIGS. 2A-2B illustrate formation of an optical element using ink jet printing of nanoparticle/monomer suspensions on a non-planar surface.

FIG. 3 illustrates an optical element having gradient index, nanoparticle containing layers on opposing exterior surfaces.

FIG. 4 illustrates variation of refractive index in three dimensions in each layer of a two layer optical element.

FIGS. 5A-5B illustrate a segmented optical element having segments with independently selectable refractive index gradients.

FIGS. 6A-6C illustrate representative refractive index variations for segmented elements such as illustrated in FIGS. 5A-5B.

FIGS. 7A-7B illustrate a sheet lens array based on nanoparticle containing monomer droplets.

FIGS. 8A-8C illustrate a representative optical waveguide device formed with nanoparticle containing monomer droplets.

FIG. 9 illustrates a planar prism defined by nanoparticles dispersed in polymer.

FIG. 10A illustrates an alternative prism.

FIG. 10B illustrates a refractive index profile of the prism of FIG. 10A.

FIG. 11 is a block diagram of a representative method of making optical elements by dispensing nanoparticle/monomer droplets.

FIG. 12 is an HRSTEM dark field image (5 nm scale) of dispersed monomer coated PbS nanoparticles showing contrast between a metallic core and monomer coating. Core diameter is ˜1.9 nm, shell thickness is ˜1.6 nm, total particle diameter is ˜3.5 nm, coating mass is ˜35% of total mass, and particle size is uniform.

FIG. 13 is an HRSTEM image of a cured composite film containing randomly distributed PbS nanoparticles.

FIG. 14 is an AFM 2D surface image of a PbS composite film showing well dispersed PbS nanoparticles.

FIG. 15 is a graph of a TGA overlay showing weight loss due to surface organic ligand degradation giving the mass of bound ligand, a comparison of poly(ethylene glycol)bis(carboxymethyl) ether (CTPEG) mass loss (18.47%) to original oleic acid mass loss (34.77%). A jog in curves at 700° C. indicates injection of air to oxidize a residual metallic core of the nanoparticles.

FIG. 16 illustrates a representative ligand exchange process for producing a stable nanoparticle suspension of PbS nanoparticles in hexanediol-diacrylate (HDDA).

FIG. 17 lists selected nanoparticle materials and associated refractive indices in a hexanediol diacrylate (HDODA) monomer.

FIG. 18 is an IR spectrum (absorbance versus wavelength) obtained from a film (1 mm thickness) of AHA-functionalized ZnS nanoparticles (50%) in HDDA.

FIG. 19 is an IR spectrum (absorbance versus wavelength) obtained from a film (0.1 mm thickness) of AHA-functionalized PbS nanoparticles (30%) in HDDA.

FIGS. 20A and 20B are ¹H NMR spectra illustrating a spectrum obtained from a free oleic acid surface ligand (FIG. 20A) and the oleic acid surface ligand when bound to a nanoparticle (FIG. 20B).

FIGS. 21A and 21B are ¹H NMR spectra illustrating a spectrum obtained from a free AHA-surface ligand (FIG. 21A) and the same AHA-surface ligand when bound to a nanoparticle (FIG. 21B).

FIG. 22 is a ¹H NMR spectrum of a particular embodiment of the disclosed nanoparticle comprising multiple mercaptoethanol surface ligands.

FIG. 23 is a wide angle x-ray diffraction (WAXD) spectrum obtained from one embodiment of the disclosed nanoparticle.

FIG. 24 is a wide angle x-ray diffraction (WAXD) spectrum obtained from one embodiment of the disclosed nanoparticle.

FIG. 25 is a thermogravimetric analysis plot of a mercaptoethanol-stabilized ZnS nanoparticle.

FIG. 26 is a thermogravimetric analysis plot of the mercaptoethanol-stabilized ZnS nanoparticle of FIG. 25 after it has been modified with an acetoxy group to provide an acetoxyethanethiol-stabilized ZnS nanoparticle.

FIG. 27 is a thermogravimetric analysis plot obtained from a 6-mercapto-1-hexanol-stabilized ZnS nanoparticle.

### DETAILED DESCRIPTION

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus' are referred to as “lowest,” “best,” “minimum,” or the like. It will be appreciated that such descriptions are intended to indicate that a selection among many used functional alternatives can be made, and such selections need not be better, smaller, or otherwise preferable to other selections.

Disclosed herein are methods, apparatus, and components that are based on inkjet printing (IJP) processes that produce functional polymer matrix nanocomposites containing composition gradients. In typical examples, gradient nanocomposites are produced with a photosensitized liquid phase (“ink”) deposited layer-by-layer via free radical photopolymerization to form a thermoset matrix composite. The ink comprises a monomer that contains well-dispersed nano-sized particles such as ceramic lead sulfide particles. A single fabricated component can be formed so as to include nanoparticles of various compositions, and the monomer/nanoparticle mixtures used can have varying concentrations of nanoparticles. A single component can be made using a plurality of monomer/nanoparticle compositions/concentrations that supplied from one or more ink jet print heads. Concentrations of nanoparticles can be selected by printing monomer without nanoparticles along with the monomer/nanoparticle mixtures. The resulting nanocomposites can have precisely controlled variations in composition due to the spatial and compositional precision available with ink jet printing. Any of various polymerizable materials can be used as described below.

In the disclosed examples, the fluids or “inks” contain well dispersed nanoparticles in various concentrations. The particles have an affinity to aggregate and are generally surface treated in order to form stable colloidal suspensions. Nanoparticle size is generally less than about 1/10 of a wavelength of the electromagnetic radiation with which a nanocomposite is to be used to avoid Rayleigh scattering and obtain transparent polymer composites. For optical components for use at visible wavelengths, nanoparticle sizes less than about 1/10 of 400-800 nm are used, and nanoparticle surface functionalizations such as those mentioned above are used to eliminate or reduce nanoparticle aggregation. The refractive index of such composites typically varies linearly or approximately linearly with volume fraction of inorganic additive.

Surface coverage of nanoparticle coatings can be evaluated using thermogravimetric analysis (TGA) measurements of polymer stabilized particles to estimate the amount of surface bound ligands. In some examples, experimental determinations via TGA were performed for comparison with calculated values estimated from TEM photomicrographs. The experimental TGA values for mass loss of the organic stabilizing ligand generally correspond to calculated values. Therefore, TGA represents an excellent tool for the characterization of the amount of surface bound ligand.

Nanoparticles of substantially transmissive materials are used to produce refractive index variations in a composite. In some disclosed examples, lead sulfide (PbS) nanoparticles are used. PbS has a relatively refractive index and can be introduced into a polymer matrix to create high refractive index nanocomposites, typically for use in the infrared. In other examples, ZnS particles are used for visible light applications. For example, PbS nanoparticles can be introduced into poly(ethylene oxide) or gelatin to produce nanocomposites with increasing refractive index in one or more locations. However, such polymer matrices are water-soluble and particle-matrix interactions are weak. For practical applications, water insolubility, good thermal stability, and robust mechanical properties are needed, in addition to optical clarity.

In some examples, optical devices such as flat lenses are formed with selected refractive index variations. Lens refractive index and index gradient are determined by volume concentration of functionalized nanoparticles suspended in a transparent polymer matrix. Nanoparticles with high refractive indices are generally preferred so that nanoparticle concentrations can be reduced. Gradient refractive index (GRIN) based lenses, prisms, filters, reflectors, optical waveguides, optical adhesives, antireflective films, and other optical devices can be formed.

Structural nanocomposites can also be produced using carbon nanotubes (CNT) in a liquid crystal polymer matrix. CNTs can be aligned using an electric field, magnetic field, or polarized light to align the liquid crystal polymer matrix that then aligns CNTs via, for example, surface tension. CNTs greatly increase composite stiffness of the composite. CNT/molecular alignment during drop by drop printing (for example, ink jet printing) permits CNT orientation to vary in three dimensions.

Functionalized nanoparticle (NP) surfaces with an adsorbed monolayer can provide steric stabilization, prevent particle agglomeration, and enable formation of stable colloidal suspensions in a reactive monomer. In some examples, such a stabilizing layer is a low molecular weight polymer such as poly-tetrahydrofuran or polyethylene glycol. Generally, the stabilizing layer can be any ligand that is compatible with the monomer and stable suspensions are used as “inks” in inkjet deposition. The suspensions are based on surface-treated nanoparticles dispersed in a liquid monomer matrix. Surface tension stabilizes the individual suspended nanoparticles so that the nanoparticles tend to remain in suspension. For most applications, the nanoparticles must be discrete so as to permit high optical transmissivity, and the nanoparticles are preferably of uniform shape and size.

In typical examples, surface treated nanoparticles are mixed with transparent monomers and applied with inkjets. In one example, a nanoparticle suspension is applied with a first inkjet and a second inkjet applies monomer alone. Multiple nozzle printheads can be used as well. Nanoparticle suspensions and monomer are applied to form optical elements with predetermined refractive index patterns.

In some embodiments, the deposited layers/droplets are UV cured. Typically, layers are cured in stages. A level of cure of a layer is selected so as to form a seamless interface with a subsequent layer. A cure of between about 60 to 80% for the current layer allows sufficient interdiffusion of layers so that layers knit together well and with reduced optical discontinuity between layers.

In most examples, a monomer refractive index is relatively low (between about 1.4 and 1.6, typically about 1.5). Nanoparticle refractive index is generally relatively high (such as greater than about 2.5, such as about 4.0) so that a relatively dilute nanoparticle suspension is adequate to produce adequate refractive index differences. For example, nanoparticle concentrations of less than 30%/volume are suitable. Relatively dilute suspensions also tend to be associated with low suspension viscosities. Bubble formation is reduced, eliminated, or controlled by microscale mixing in which droplets are applied on top of each other. Air bubbles are not trapped, and local mixing produces substantially void-free films. Layers can be as thin as 1, 2, 5, or 10 μm with drop volumes as small as 0.5, 1, 2, or 5 pl. Microscale mixing also permits nanoparticle concentration control and obviates the need for multiple print heads as multiple concentrations can be achieved with two print heads, one containing nanoparticle-free monomer, the other with a nanoparticle suspension. Droplet impacts result in local turbulence to facilitate mixing so that concentration gradients can be finely tuned.

Residual stresses in layers and elements can be reduced or eliminated by curing the deposited material in small, randomly distributed areas. Each small area to undergo a stress relaxation before the entire layer area is joined via UV exposure of additional material that is cured to fill in the areas between the randomly exposed resin to complete the optical layer.

Partial curing can be achieved with a limited, incremental dose of UV light that causes the resin to cure partially, so that when a layer is added on top there is slight interdiffusion of the layers that results in a final layer that is seamless (i.e., there is little or no stratification of the layers or formation of optical artifacts due to layer interfaces). The appropriate UV dose for curing can be controlled by regulating the light intensity or the exposure time or both. Uniform or non-uniform UV exposures can be used, and wavelengths or wavelength ranges can be selected based on monomer curing characteristics.

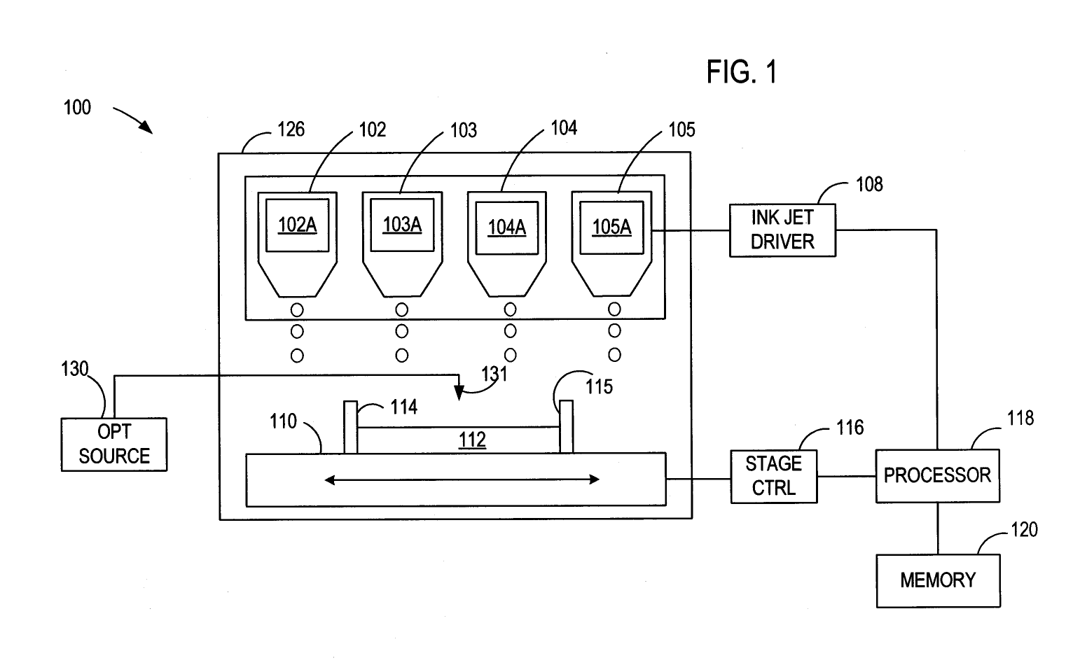

Dispensing heads as shown in FIG. 1 can use nanoparticle containing suspensions to form a wide variety of gradient index optical elements, step index optical elements, or other optical elements. The nanoparticle suspensions preferably include well dispersed nanoparticles that exhibit little or minimal aggregation. A photosensitized liquid phase permits photopolymerization and photocuring layer-by-layer to form an optically transparent, thermoset matrix composite. Optical elements formed in this manner can be flat, spherical, or other shapes with some or all optical power provided by a gradient refractive index. For both optical clarity in composites and for droplet dispensing, nanoparticle suspensions are arranged so as to be dispensed by inkjet nozzles without clogging. Suitable nanoparticles and compositions include PbS particles that are surface stabilized with a monodentate ligand such as an oleic acid ligand attached during particle synthesis. One suitable monomer is hexanediol-diacrylate (HDDA), which is optically clear and cures rapidly in response to ultraviolet exposure. As-synthesized oleic capped PbS does not readily disperse in HDDA so that a stable colloidal suspension with discrete nanoparticles cannot be formed. Mixing oleic stabilized nanoparticles with HDDA does not provide a stable suspension, and the PbS nanoparticles settle. Such oleic acid capped PbS nanoparticles can be surface treated so as to be soluble in less polar organic monomers such as HDDA. In one example, spherical, oleic acid stabilized PbS nanoparticles having a diameter of about 3 nm are surface modified with one or more bidentate ligands such as amine terminated polytetrahydrofuran (ATHF), Mₙ˜1100, and poly(ethylene glycol)bis(carboxymethyl) ether (CTPEG), Mₙ˜600.

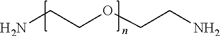

poly(ethylene oxide)bis(ethylamine) terminated (ATHF)

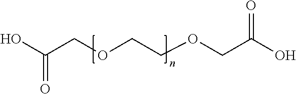

poly(ethylene glycol)bis(carboxymethyl) ether (CTPEG)

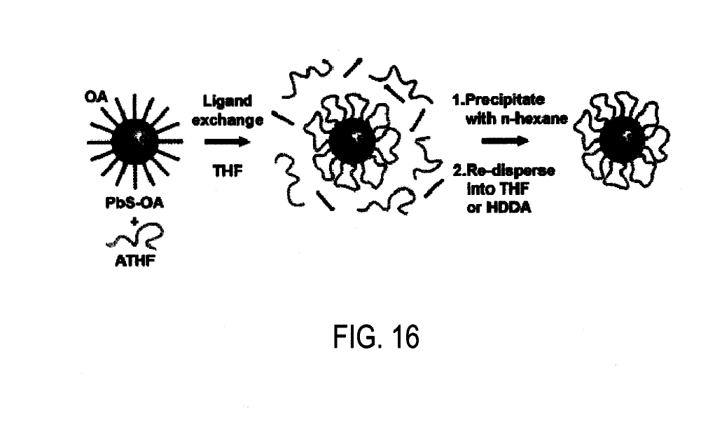

Other representative modifiers for functionalizing nanoparticles include but are not limited to amine terminated polytetrahydrofuran (ATHF), carboxy-terminated PEG, 3-acryloxyproppyl-trimethoxysilane (ACTMS), 3-aminopropyltriethoxysilane (AMPTES). Properties of ACTMS and AMPTES are described in McMorrow et al. “Particle Surface Treatment for Nanocomposites Containing Ceramic Particles,” Composite Interfaces 13:801-817 (2006), which is incorporated herein by reference. Any number of other modifiers are suitable. Representative monomers include hexanediol-diacrylate (HDODA) and photoinitiators such as Irgacure 369, Irgacure 184, or Irgacure 819 have been used. HDODA and Irgacure 184 are also described in this reference. Optically transparent monomers with viscosities of less than 15, 20, 25, 50, 70, or 100 cP are suitable. In some examples, monomer viscosity can be reduced during fabrication process by heating, and more viscous materials can be used. A representative process for producing functionalized PbS nanoparticles in HDDA is illustrated in FIG. 16.

Curing processes can be evaluated by characterizing the conversion correlating DSC extent of cure versus radiation dose with dynamic mechanical analysis characterization of elastic modulus obtained at various degrees of cure. An extent of cure is typically selected so that partially cured polymer is soft enough so that a subsequent layer of monomer can diffuse into the surface of a previous layer to form a seamless interface.

### Representative Nano-Composite Print System

With reference to FIG. 1, a representative apparatus includes ink jet heads 102-105 that are configured to produce droplets of monomers or monomer suspensions that include one or more nanoparticles, or monomer compositions without nanoparticles. An inkjet driver 108 is coupled to the ink jets 102-105 and is configured to be responsive to droplet configuration provided by a processor 118. In some examples, the processor 118 retrieves and stores droplet configurations in a memory such as RAM or ROM, or in a storage device 120 such as a hard disk. In still other examples, droplet configurations are provided over a local or wide area network (not shown in FIG. 1).

Each or the ink jets 102-105 can be individually configured to provide droplets of different sizes, having different (or no) nanoparticles, nanoparticles of different compositions, concentrations or shapes, differing monomer compositions, at differing dispensing rates, or other differing characteristics. In some cases, one or more ink jet heads can be configured to provide a common composition. Nanoparticle suspensions can be introduced into chambers 102A-105A that are integrated with the ink jet heads 102-105, or externally situated supply containers can be used.

A substrate 112 is situated on a translation stage 110 that is coupled to a stage controller 116. The processor 118 is coupled to the stage controller 116 so that droplets from a selected ink jet head are directed to selected locations on the substrate 112. The substrate 112 is situated within a retainer 114, and droplets are generally applied so that a composite layer formed on the substrate 112 has an approximately uniform thickness and extends to an interior wall 115 of the retainer 114. The retainer 114 can be formed of a material to which the monomer compositions do not adhere or adhere weakly so that a formed composite can be removed as a single piece that is not secured to either the substrate 110 or the retainer 114. In other examples, a formed composite layer is fixed to the substrate 110 and is separated only from the retainer 114. In other examples, a formed optical element can be supplied with a retainer, and separation is not required.

While FIG. 1 illustrates a system in which a substrate is scanned with respect to a set of ink jet heads, in other systems, one or both of the substrate or the ink jet heads are scanned. For example, the ink jet heads can be coupled to a translation stage so as to be translatable in one, two, or more dimensions. In some applications, a composite layer thickness increases during formation so that ink jet head displacements in a direction away from the substrate are desirable.

The system of FIG. 1 can be situated in a controlled atmosphere container 126 so that droplets are applied in a selected environment that can include a preferred mixture of gases in a preferred temperature range and pressure. Substrate and monomer compositions can be held at one or more suitable temperatures, and droplets can be applied at selected rates. Droplets can be cured or partially cured using an ultraviolet light source 130 that directs a uniform or patterned curing beam 131 to the substrate 112. Sets of droplets can be applied and then the sets partially cured so that at least some droplets partially mix and droplet boundaries are reduced or eliminated. IN some examples, a chamber 126 is provided to permit exposure to a selected ambient environment during dispensing, such as a non-oxidizing ambient.

### Representative Nano-Composite Optical Elements

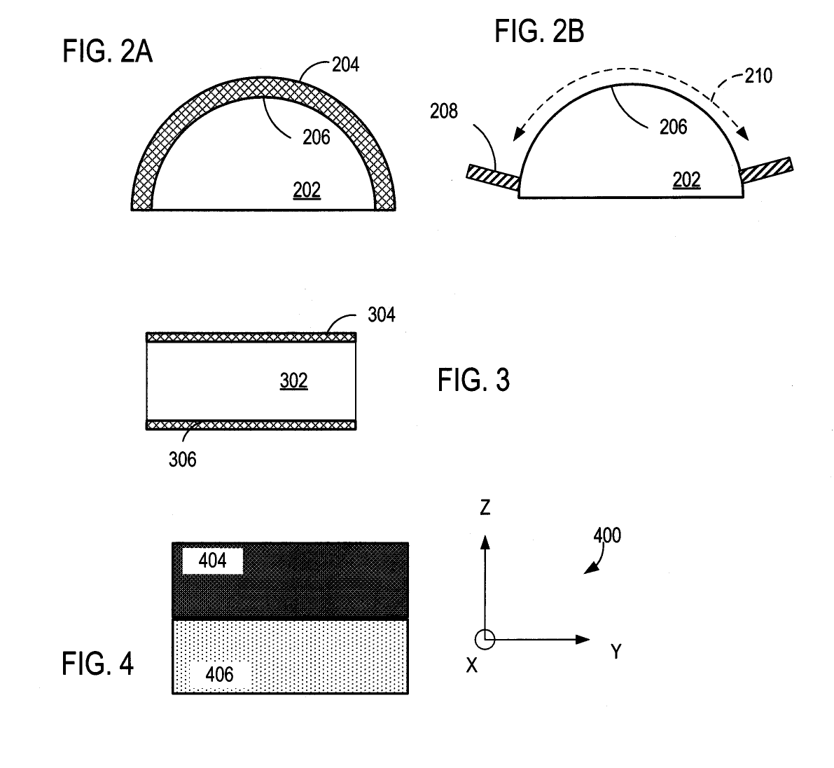

FIGS. 2A-2B and FIG. 3 illustrate representative optical elements formed based on nanoparticle droplets. Referring to FIGS. 2A-2B, a nanoparticle/polymer layer 204 is situated on a curved surface 206 of a substrate 202. The substrate 202 can be formed of a transmissive optical material such as glass, fused silica, or an optical plastic. In most examples, the substrate 202 is transmissive so that a transmissive optical element can be produced, but in other examples, absorbing and reflective materials can be used to form a reflective optical element. In still other examples, a surface such as the surface 206 is provided with a reflective coating such as a dielectric coating or metallic coating to make a reflective optical element. In the example of FIG. 2, the curved surface 206 provides considerable focusing optical power, and this power can be adjusted with a selected refractive index distribution in the layer 204. For example, the layer 204 can be configured to form an aspheric optical surface based on the surface 206 and the refractive index distribution.

Layers with varying (or constant) refractive index can be configured to adjust (increase or decrease) surface power. Alternatively, such layers can be used provide a refractive index distribution for aberration correction. For example, a variable refractive index layer can serve as an aberration correction surface for a telescope lens or mirror. In one example, a nanoparticle based gradient index layer can be configured as a Schmidt correction plate for a Schmidt Cassegrain telescope.

For curved surfaces, quasi-planar droplet dispensing can be achieved by rotating the substrate. For example, rotation of the surface 206 as indicated by an arc 210 permits normal incidence with a surface area defined by a retainer 208. In other alternatives, dispensing ink jets are rotated, or both ink jets and substrate are rotated for dispensing on non-planar surfaces.

Referring to FIG. 3, an optical element includes a substrate 302 having major surfaces 304, 305 on which gradient-index layers 306, 307 are situated. The gradient-index layers 306, 307 can be based on nanoparticles distributed in a monomer and each of these layers can have the same or different compositions, and define different refractive index profiles. For example, the refractive index profile of the layer 306 can correspond to a positive (converging) lens element and the index profile of the layer 306 can correspond to a negative (diverging) lens element. The substrate 302 can be an isotropic material, a crystalline material, a solid gradient index material such as a conventional gradient index lens. With selection of a suitable substrate or a suitable surface treatment for the substrate 302, one or both of the layers 306, 307 can be removed to form flexible gradient index sheets or films that can be applied to planar or non-planar surfaces, or used as flexible sheets.

FIG. 4 illustrates a cross-section of an optical element 401 formed of a first gradient index layer 402 and a second gradient index layer 404. Referring to a rectangular coordinate system 400, a refractive index in either or both of the layers can vary as a function of X, Y, or Z based on numbers, locations, and compositions (including compositions corresponding to droplet mixing) of dispensed drops. X and Y refractive index variations are controlled as droplets are dispensed at various targeted locations; Z-variations can be obtained by varying droplet density, composition, or other characteristic as a layer is built up at a particular location. In most convenient examples, gradient index layers formed with nanoparticle containing droplets tend to have approximately planar surfaces as surface curvature is not required to provide optical power. Stacks of one, two, or any number of layers can be provided. As shown in FIG. 4, a substrate is not required.

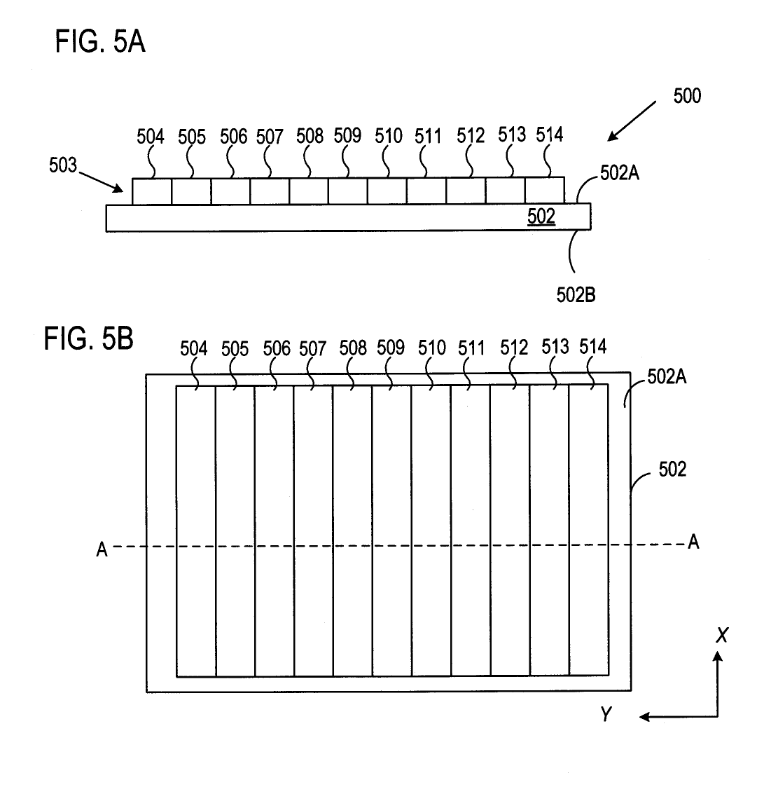

With reference to FIGS. 5A-5B, an optical element 500 includes a gradient index layer 503 situated on a surface 502A of a substrate 502. The gradient index layer 503 defines a plurality of segments 504-514 that have refractive indices that are independently, periodically, or otherwise selected. Refractive index variation within or between segments can be continuously variable or stepped. In the example of FIGS. 5A-5B, the segments 504-514 are linear segments that extend along an X-direction. In other examples, circular, polygonal, curved, or other segment shapes can be used. Segment widths can be variable, and stacked segments can be provided with, for example, a series of X-directed segments situated on a series of Y-directed segments. Arrays of rectangular, square, or polygonal segments can be used to form grid-like arrays. Optical elements such as cylindrical lens arrays, fly-eye lenses, Fresnel lenses with gradient index and/or stepped index segments can be provided.

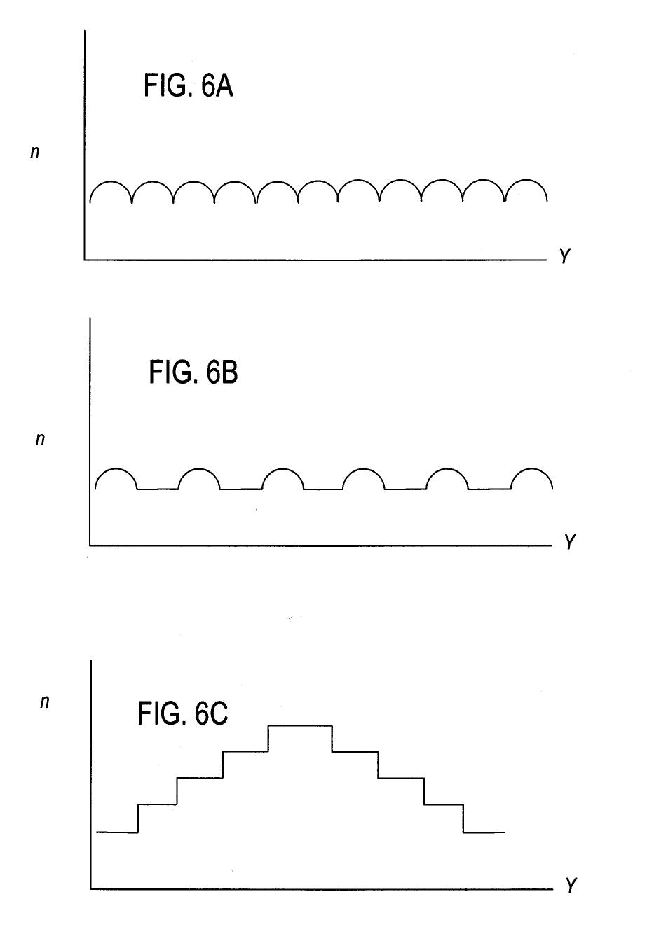

FIGS. 6A-6C illustrate representative refractive index profiles that can be associated with configurations such as that of FIGS. 5A-5B. The profiles of FIGS. 6A-6C are shown as functions of a Y-coordinate, but variation along a lengthwise (X) direction is also possible and along with other variations as discussed above.

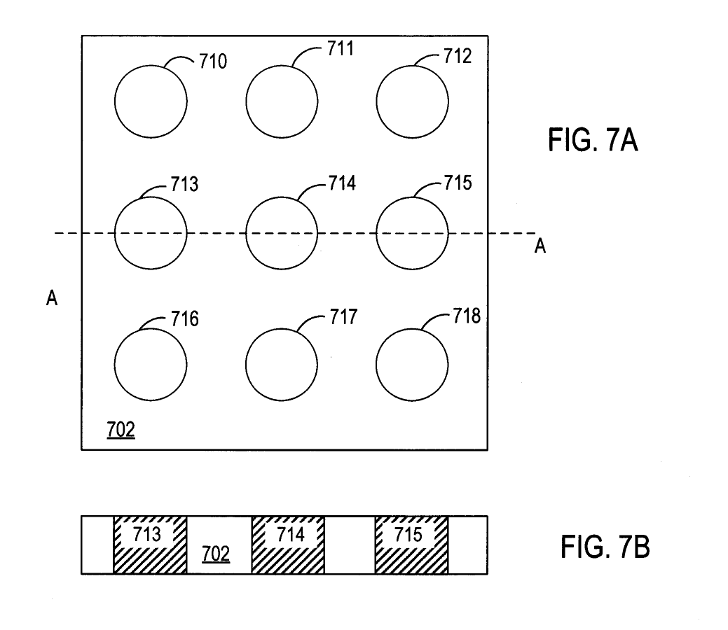

Referring to FIGS. 7A-7B, a sheet 702 contains individual optical elements 710-718. Each of the optical elements 710-718 can be different or the same. For example, a sheet of lenses can be formed, and individual lenses removed as necessary. Lens arrays can also be provided, if desired. In some examples, lenses such as the optical elements 710-718 are arranged so as to contact or nearly contact adjacent optical elements to form a fly eye lens. Lenticular lens arrays for 3-D imaging systems or illumination systems can be provided, and arrays of cylindrical or spherical lenses can be formed with flat sheets having refractive index variations that produce optical path differences corresponding to those produced with conventional non-planar lens elements.

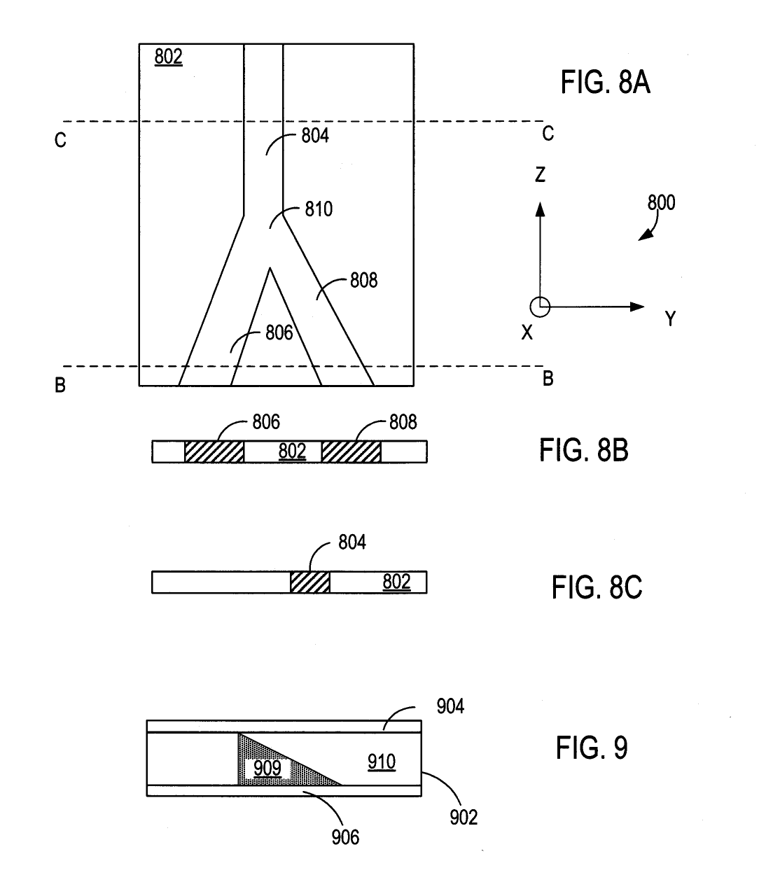

FIGS. 8A-8C illustrate representative optical waveguide structures formed using nanoparticle/monomer suspensions. A waveguide 804 is coupled to waveguides 806, 808 via a Y-branch 810. The waveguides 804, 806, 808 are defined in a single nanoparticle/monomer layer 802 that can be formed on a substrate (not shown in FIGS. 8A-8C). Waveguide indices of refraction can be varied in three dimensions to achieve intended waveguide properties, i.e., refractive index n=n(X, Y, Z), wherein coordinates X, Y, Z are defined by a coordinate system 800. Refractive index variation in X and Y directions can be selected to produce step or gradient index waveguides. Although cross sections of the waveguides 804, 806, 808 are shown as rectangular, waveguide refractive index can be configured to produce circular or other waveguide shapes by appropriate dispensing of nanoparticle monomer suspension droplets. Refractive index can be tailored to produce single mode, few mode, or multimode optical fibers as drop by drop formation permits establishment of precise refractive index, for both large and small refractive index changes. Refractive index can also vary along a Z-direction so that optical modes can be tailored for coupling to other waveguide devices, free space optics, or to control mode diameters and power splitting ratios at the Y-branch 810. Curved waveguides can be readily made, and the linear waveguides of FIGS. 8A-8C are illustrated for convenience.

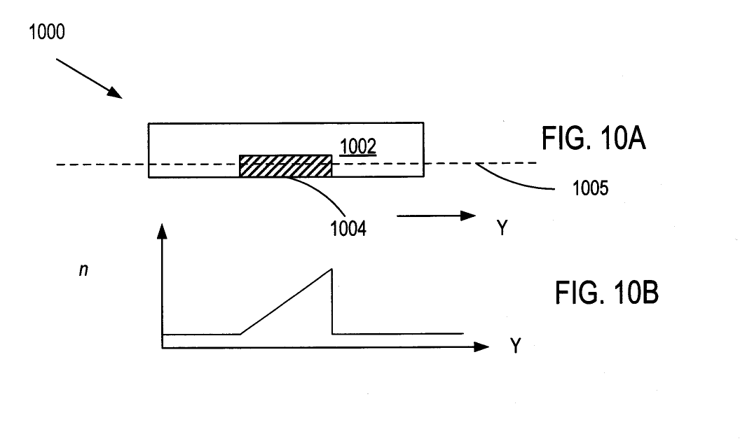

FIGS. 9-10A illustrate planar prisms formed with nanoparticle containing composites. Referring to FIG. 9, a layer 902 formed with droplets is situated between substrate or protective layers 904, 906. A portion 910 of the layer 902 has a first refractive index, while a tapered region 909 has a second refractive index that is larger than the first refractive index. An optical beam propagating through the layer 902 experiences a linearly varying optical path difference corresponding to that produced with a conventional prism.

FIG. 10A illustrates a prism 1000 formed by a nanoparticle/composite layer 1002 having a first refractive index except in a portion 1004. The refractive index in the portion 1004 is linearly varying in a Y-direction. Refractive index of the layer 1002 is shown in FIG. 10B as a function of a Y coordinate. The portion 1004 has a rectangular cross-section, but its refractive index increases linearly so as to produce an optical path difference corresponding to that produced with a conventional prism. In other examples, the refractive index in the portion 1004 can be smaller than in the remainder of the composite layer so as to produce a prism deflection that would opposite that produced with the prism of FIG. 10A.

### Representative Method of Fabrication

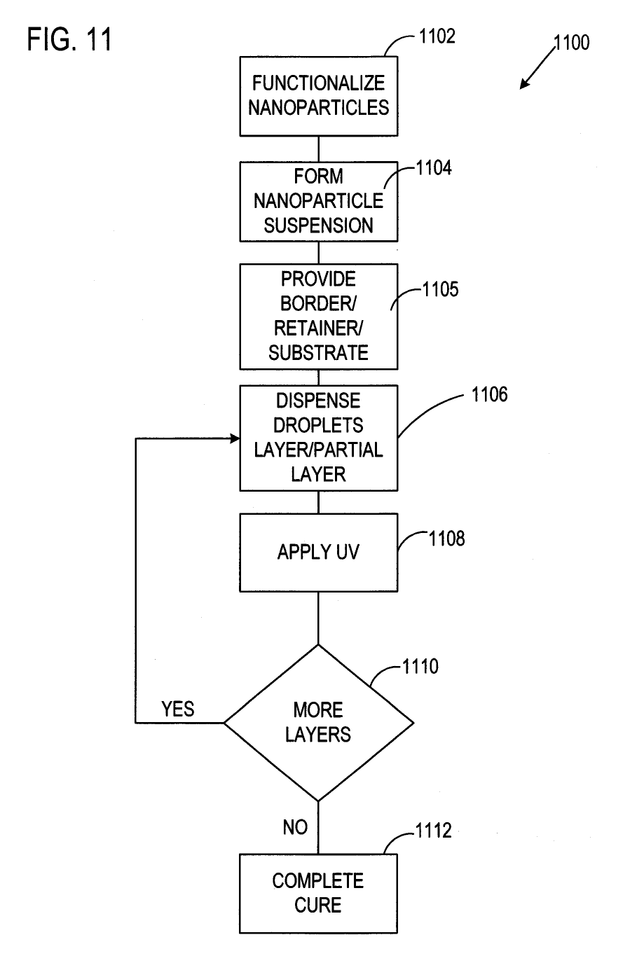

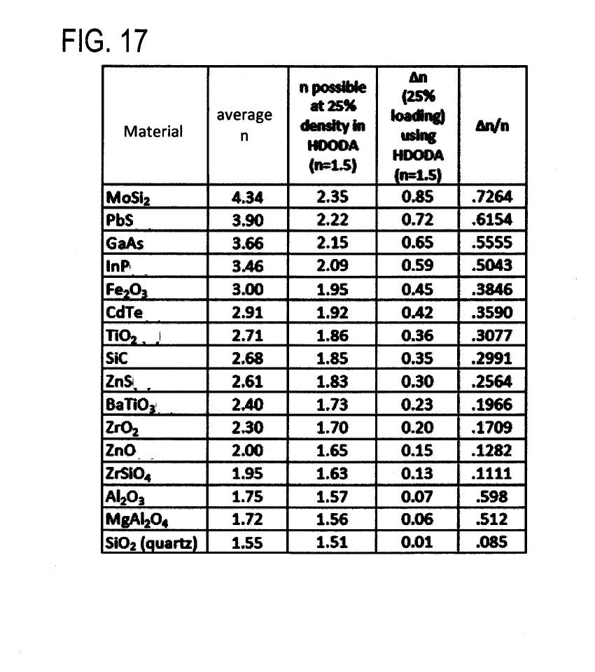

Referring to FIG. 11, a representative method 1100 includes functionalizing one or more types of nanoparticles at 1102. Typically, nanoparticles are selected that permit relatively large refractive index differences with respect to monomers in which the nanoparticles are to be dispersed. Monomer refractive indices are generally between about 1.4 and 1.6, and nanoparticles of PbS with a refractive index of about 4 provide a significant refractive index difference. Refractive index differences of at least about 0.1, 0.2, 0.5, 1, 2, or more can be used. Representative nanoparticles include carbon nanotubes, and particles of silver, cerium oxide, titanium dioxide, iron, or other metals, metal oxides and chalcogenides, and semiconductors. Some examples are listed in FIG. 17. In some examples, nanoparticles are selected to have a lower refractive index than a polymer. Selection of a particular type of nanoparticle can depend on wavelength of intended use. Some semiconductor materials are not appreciably transmissive at visible wavelengths and are more useful at infrared and near infrared wavelengths.

Nanoparticle surfaces are generally functionalized with an adsorbed monolayer that provides steric stabilization, reduces particle agglomeration, and permits formation of stable colloidal suspensions in a reactive monomer. In one example, the stabilizing adsorbed layer is a low molecular weight polymer such as poly-tetrahydrofuran or polyethylene glycol, but other ligands that are compatible with a selected monomer can be used.

At 1104, a nanoparticle suspension is formed with a suitable monomer (generally a photopolymer) and the selected nanoparticles. At 1105, a retainer is situated on a substrate surface to provide an area for drop by drop buildup of nanoparticle/polymer layer. At 1106, one or more dispensing heads dispense droplets to form a layer or a portion of a layer within the retainer based on an optical element refractive index profile to be achieved. Dispensing is generally performed in a controlled atmosphere and a controlled temperature. Typically, at least two droplet dispensers are used, one of which is provided with a low (or zero) nanoparticle concentration so that nanoparticle concentrations as applied to the substrate can range from zero to a maximum concentration. Nanoparticle suspensions (and monomer without nanoparticles) are dispersed one at a time, or multiple ink jet dispensers (or multi-nozzle dispensers) provide multiple droplets. In a typical example, a first dispenser produces droplets of a nanoparticle/monomer suspension and a second dispenser produces droplets of monomer without nanoparticles. Droplet dispensing rates can be used to provide selected nanoparticle concentrations, and a substrate, the dispensers, or both can be scanned to mix droplets of one or more nanoparticle suspensions and/or monomer without nanoparticles. Scanning is also used to provide suitable spatial distributions at the substrate so that local concentrations of functionalized nanoparticles are selected to produce optical elements with desired refractive index gradients.

At 1108, the dispensed droplets are exposed to ultraviolet radiation or otherwise treated to partially cure the nanoparticle/monomer mixture. A partial cure is used so that droplets for adjacent layers tend to merge so as to reduce droplet boundaries which can produce unwanted light scattering. Extent of cure is selected so as to provide a “seamless” interface with reduced discontinuity between layers. A conversion/cure of between 20% and 90%, 30% and 80%, 40% and 80%, 50% and 80%, or 60% and 80% for a current layer allows sufficient interdiffusion with other layers and serves to knit or bond the layers adequately. A curing process can be evaluated by characterizing the conversion correlating differential scanning calorimetry (DSC) extent of cure versus radiation dose with dynamic material analysis (DMA) data characterizing elastic modulus obtained at various degrees of cure. A partially cured monomer is preferably soft enough so that a next layer of monomer added can diffuse into the surface of a previous layer to form a seamless interface.

At 1110, it is determined if additional layers are needed. If so, additional layers of droplets are dispensed at 1106. Otherwise, curing is completed with an additional ultraviolet exposure at 1112. In some cases, the cured layers are removed from the substrate and the retainer to provide a flexible optical element having planar input/output surfaces.

In order to define a target area, a border can be provided by dispensing and curing monomer at a perimeter, or a separate retainer or frame can be provided. If a perimeter is defined by printing a border, a separate frame is not needed. Droplets for a device under fabrication can then be applied so as to fill-in the area defined by the border. In addition, partial or complete curing of either the fill-in area or a perimeter border can be done in small areas that are randomly selected. Such a procedure tends to reduce stress and shrinkage.

### Representative Implementation

Nano-composite films were formed by inkjet printing using a DMP-2800 Dimatix Materials Printer available from Fujifilm-Dimatix. Using this printer, 15 layer HDDA monomer films containing a photoinitiator having a thickness of ˜0.18+/−0.2 mm were printed on a polished silicon wafer with a mirror finish. The deposited films had a smooth, regular appearing surface finish to the films. Each sample was flushed (purged) with argon for 15 minutes to remove absorbed (dissolved) oxygen and then cured by exposure to UV light. Photocuring was done with an LED array device, from Clearstone Technologies, Minneapolis, Minn., which delivers a nominal intensity of 210 mW/cm². The array includes 18 LEDs and irradiates a 20 cm²area. The degree of conversion of the cured films was determined by DSC analyses. About 10 mg of cured film was placed in a DSC pan and ramped at 20° C./min to 300° C. The printed films were generally cured to approximately 93% conversion.

### Representative Nanoparticle Assessment

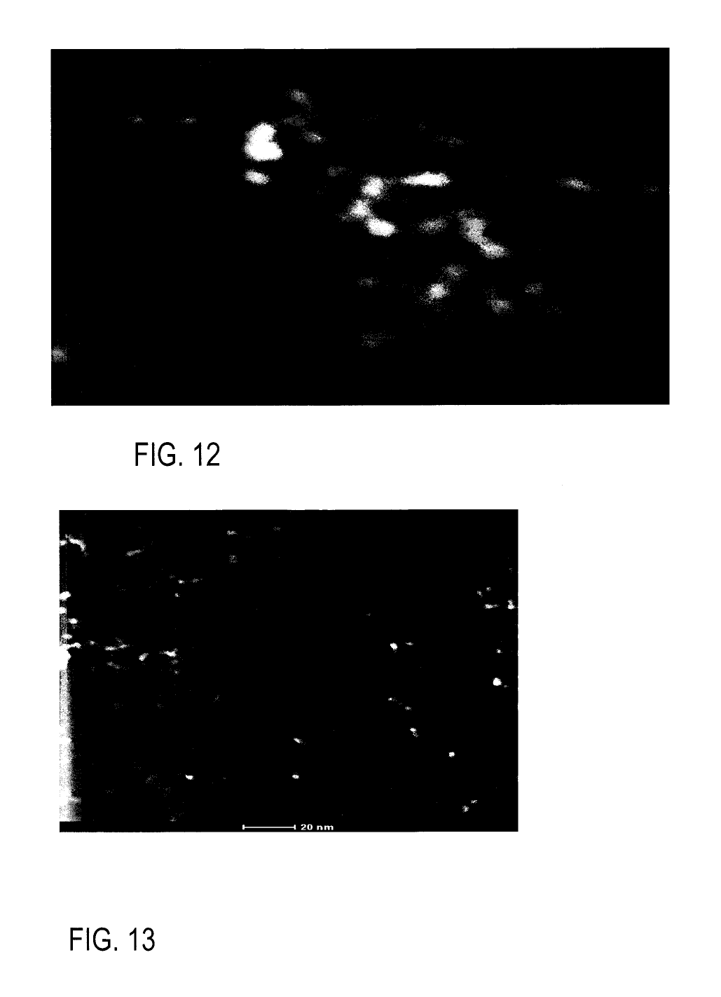

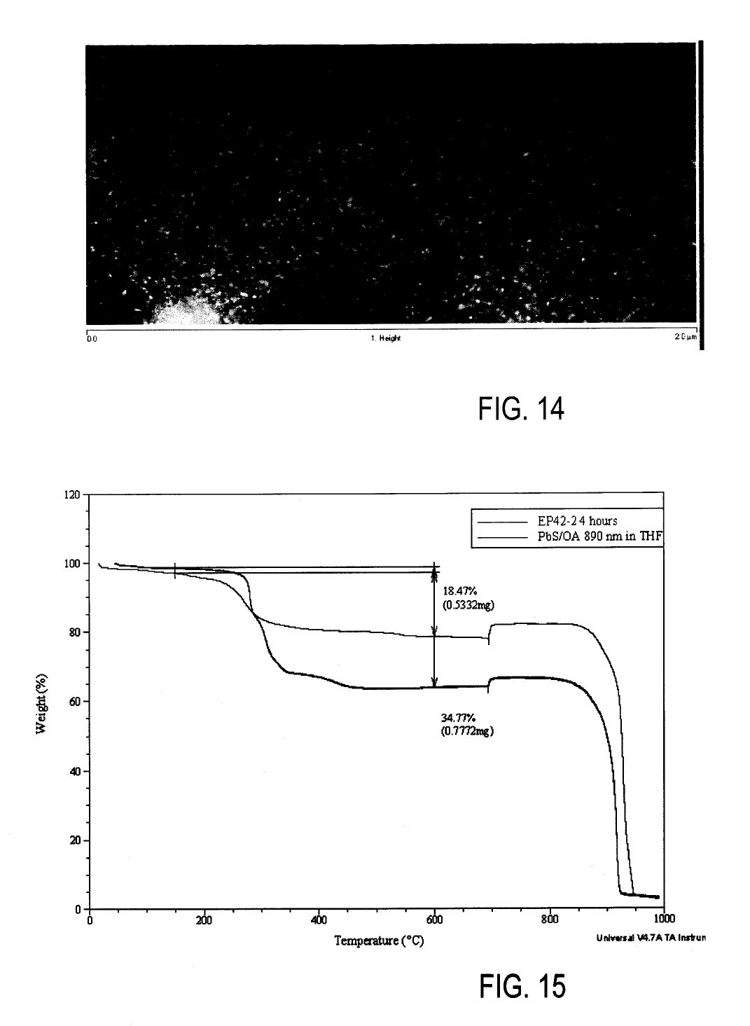

High resolution scanning transmission electron microscopy (HRSTEM) and atomic force microscopy (AFM) were used to assess nanoparticles. HRSTEM scans were performed with a Titan 80-300 (STEM) instrument to verify size, shape and state of aggregation of synthesized nanoparticles both before and after a ligand exchange reaction. Both darkfield and lightfield images were obtained. High resolution darkfield images were particularly useful for distinguishing core shell morphology of the particles as shown in FIGS. 12-13. One important parameter concerns the surface coverage of the nanoparticles with the polymer ligand. From the core shell structure shown one can estimate the relative masses of the coating and the metallic core. In this case the polymer surface layer represents about 35% of the total mass. An AFM scan of the smooth surface of a 15 layer inkjet printed composite film is shown in FIG. 14. This indicates that the nanoparticles are very well distributed. Such films tend to be optically transparent, and exhibit little scattering.

An amount of surface bound ligand can be important for device performance. While HRSTEM allows estimation of shell thickness and mass, a more exact mass can be determined by thermogravimetric analysis (TGA). TGA data also can also provide information about how compact the shell is and how tightly bound the ligand is to the surface. TGA measurements of polymer stabilized PbS particles were performed to determine the amount of surface bound ligands. Experimental determinations via TGA analyses that were performed were compared with calculated values estimated from HRSTEM photomicrographs. Mass loss wt % of ATHF coated particles indicates that the total mass of a nanoparticle is composed of 65 wt % PbS core and 35 wt % organic stabilizing ligand, which agrees with the estimated value from HRSTEM photos. Therefore, TGA is suitable for quantitative characterization of the amount of surface bound ligand.

TGA curves for coated particles show that the weight loss is initially gradual, but becomes rapid around the ligand decomposition point. For oleic acid this is around 308° C. For polymeric ligands, the decomposition curves for the chemisorbed ligand are shifted to higher temperatures compared to the pure uncoupled ligand. This is a result of the strength of chemisorption of the polymer onto the particle surface. For ATHF the weight loss calculated from the TGA curve is about 35%. This correlates with the percentage weight loss of the ligand mass fraction estimated from HRTEM photos as discussed above. For the CTPEG polymer, the TGA weight loss indicates that the polymer coating comprises about 18.5% of the total weight (see FIG. 15). This is consistent with the notion of a smaller hydrodynamic volume of the polymer ligand shell in the case of CTPEG. Compared with ATHF for which Mₙ=1100, CTPEG has Mₙ=600 and, in effect, has twice the number of functional groups per molecule, so tends to be more tightly bound and compact on particle surfaces.

### Representative Materials and Compositions

### I. Introduction

Representative compositions suitable for the above are described below. The singular forms “a,” “an,” and “the” refer to one or more than one, unless the context clearly dictates otherwise. For example, the term “comprising the compound” includes single or plural molecules and is considered equivalent to the phrase “comprising at least one compound.” The term “or” refers to a single element of stated alternative elements or a combination of two or more elements, unless the context clearly indicates otherwise. As used herein, “comprises” means “includes.” Thus, “comprising A or B,” means “including A, B, or A and B,” without excluding additional elements. A wavy line (“ [symbol] ”), is used to indicate a bond disconnection, a dashed line (“- - -”) is used to illustrate that a bond may or may not be formed at a particular position, and “ [symbol] ” line is used to illustrate optional isomers (e.g., in an olefin, a [symbol] line indicates that the olefin may be the Z (or cis) or E (or trans)) isomer. A person of ordinary skill in the art would recognize that the definitions and formulas provided herein are not intended to include impermissible substitution patterns (e.g., pentavalent carbon, and the like). Accordingly, any bond indicated as being optional may be excluded from a particular formula where the bond's presence would produce an impermissible substitution pattern. Such impermissible substitution patterns are easily recognized by a person of ordinary skill in the art.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting.

In order to facilitate review of the various examples of this disclosure, the following explanations of specific terms are provided:

Aliphatic: A saturated or unsaturated monovalent hydrocarbon having a number of carbon atoms ranging from at least one to about 40 (e.g., C₁₋₄₀alkyl), which is derived from removing one hydrogen atom from one carbon atom of a parent compound (e.g., alkane, alkene, alkyne).

Aliphatic-carbonylamino: -aliphaticC(O)N(R^{b})₂, wherein each R^{b} independently is selected from hydrogen, alkyl, substituted alkyl, alkenyl, substituted alkenyl, alkynyl, substituted alkynyl, aryl, substituted aryl, cycloalkyl, substituted cycloalkyl, cycloalkenyl, substituted cycloalkenyl, cycloalkynyl, substituted cycloalkynyl, heteroaryl, substituted heteroaryl, heterocyclyl, substituted heterocyclyl. Also, each R^{b} may optionally be joined together with the nitrogen atom to which they are bound to form a heterocyclyl or substituted heterocyclyl group, provided that both R^{b} are not both hydrogen.

Alkenyl: A unsaturated monovalent hydrocarbon having a number of carbon atoms ranging from at least two to 40 (e.g., C₂₋₄₀alkenyl), which has at least one carbon-carbon double bond and is derived from removing one hydrogen atom from one carbon atom of a parent alkene. An alkenyl group may be branched, straight-chain, cyclic, cis, or trans.

Alkoxy: —O-alkyl (e.g., methoxy, ethoxy, n-propoxy, isopropoxy, n-butoxy, t-butoxy, sec-butoxy, n-pentoxy).

Alkyl: A saturated or unsaturated monovalent hydrocarbon having a number of carbon atoms ranging from at least one to about 40 (e.g., C₁₋₄₀alkyl), which is derived from removing one hydrogen atom from one carbon atom of an alkane. An alkyl group may be branched, straight-chain, or cyclic.

Alkynyl: A unsaturated monovalent hydrocarbon having a number of carbon atoms ranging from at least two to 40 (e.g., C₂₋₄₀alkynyl), which has at least one carbon-carbon triple bond and is derived from removing one hydrogen atom from one carbon atom of a parent alkyne. An alkynyl group may be branched, straight-chain, or cyclic.

Amino: —NH₂.

Aminoacyl: —NR^{a}C(O)alkyl, —NR^{a}C(O)substituted alkyl, —NR^{a}C(O)cycloalkyl, —NR^{a}C(O)substituted cycloalkyl, —NR^{a}C(O)alkenyl, —NR^{a}C(O)substituted alkenyl, —NR^{a}C(O)cycloalkenyl, —NR^{a}C(O)substituted cycloalkenyl, —NR^{a}C(O)alkynyl, —NR^{a}C(O)substituted alkynyl, —NR^{a}C(O)aryl, —NR^{a}C(O)substituted aryl, —NR^{a}C(O)heteroaryl, —NR^{a}C(O)substituted heteroaryl, —NR^{a}C(O)heterocyclyl, and —NR^{a}C(O)substituted heterocyclyl, wherein R^{a} is selected from hydrogen, alkyl, alkenyl, alkynyl, aryl, cycloalkyl, cycloalkenyl, and cycloalkynyl.

Aminocarbonylamino: —NR^{a}C(O)N(R^{b})₂, wherein R^{a} and each R^{b} are as defined herein. This group may also be generally referred to in the art as a urea group or carbamide group, but is not limited to H₂NC(O)NH₂.

Amino(carboxyester): —NR^{a}—C(O)O-aliphatic, —NR^{a}—C(O)O— substituted aliphatic, —NR^{a}—C(O)O-aryl, —NR^{a}—C(O)O-substituted aryl, —NR^{a}—C(O)O-cycloaliphatic, —NR^{a}—C(O)O-substituted cycloaliphatic, —NR^{a}—C(O)O-heteroaryl, —NR^{a}—C(O)O-substituted heteroaryl, —NR^{a}—C(O)O-heterocyclyl, and —NR^{a}—C(O)O-substituted heterocyclyl, wherein R^{a} is as recited herein. This group may also be generally referred to in the art as a carbamate group.

Aminosulfonyl: —NR^{a}SO₂aliphatic, —NR^{a}SO₂substituted aliphatic, —NR^{a}SO₂cycloaliphatic, —NR^{a}SO₂substituted cycloaliphatic, —NR^{a}SO₂aryl, —NR^{a}SO₂substituted aryl, —NR^{a}SO₂heteroaryl, —NR^{a}SO₂substituted heteroaryl, —NR^{a}SO₂heterocyclyl, —NR^{a}SO₂substituted heterocyclyl, wherein each R^{a} independently is as defined herein.

Aryl: A monovalent aromatic hydrocarbon group having 6 to 15 carbon atoms (e.g., C₆₋₁₅ aryl), which is derived by removing one hydrogen atom from a single carbon atom of the parent ring system.

Carbonylamino: —C(O)N(R^{b})₂, wherein each R^{b} is as provided herein.

Carbonylhydrazide: —C(O)NR^{a}N(R^{b})₂, wherein R^{a} and each R^{b} are as provided herein.

Carbonylthio: —C(O)SR^{a}, wherein R^{a} is as provided herein.

Carboxyester: —C(O)O-aliphatic, —C(O)O-substituted aliphatic, —C(O)O-aryl, —C(O)O-substituted aryl, —C(O)O-cycloaliphatic, —C(O)O-substituted cycloaliphatic, —C(O)O-heteroaryl, —C(O)O-substituted heteroaryl, —C(O)O-heterocyclyl, and —C(O)O-substituted heterocyclyl.

Carboxyl: —COOH or salts thereof.

Cyano: —CN.

Cycloaliphatic: A cyclic version of an aliphatic group, typically having from three to about ten carbon atoms. Typical cycloaliphatic groups include, but are not limited to, cycloalkyl, cycloalkenyl, cycloalkynyl, such as cyclopropyl; cyclobutyl (e.g., cyclobutanyl and cyclobutenyl), cyclopentyl (e.g., cyclopentanyl and cyclopentenyl), cyclohexyl (e.g., cyclohexanyl and cyclohexenyl), and the like. This term also encompasses polycyclic compounds comprising two or more rings.

Haloaliphatic: An aliphatic group wherein one or more hydrogen atoms are replaced with a halogen atom.

Halogen: Includes fluoro, chloro, bromo and iodo.

Heteroaliphatic: An alkyl, alkenyl, or alkynyl group, wherein one or more of the carbon atoms are each independently replaced with one or more heteroatoms.

Heteroaryl: A monovalent heteroaromatic group having 5 to 14 ring atoms, which is derived from removing one hydrogen atom from a single atom of the parent ring system. This term encompasses polycyclic aromatic compounds comprising two or more rings, wherein at least one ring is aromatic.

Heteroatom: Any atom that is not carbon or hydrogen. Examples include, but are not limited to, nitrogen, oxygen, sulfur, selenium, phosphorus, boron, chlorine, bromine, fluorine, and iodine.

Heterocycloaliphatic (or Heterocyclyl): A cyclic version of a heteroaliphatic group wherein a heteroatom can occupy a position that is attached to the remainder of the molecule.

Hydrazide: —NR^{a}N(R^{b})₂, wherein R^{a} and each R^{b} independently are as defined herein.

Hydroxyl: —OH.

Oxyaryl: —OC(O)aliphatic, wherein aliphatic is as defined herein.

Oxyaryl: —O-aryl.

Oxycarbonylamino: —O—C(O)N(R^{b})₂, wherein each R^{b} independently is as defined herein.

Oxy(carboxyester): —O—C(O)O-aliphatic, —O—C(O)O— substituted aliphatic, —O—C(O)O-aryl, —O—C(O)O-substituted aryl, —O—C(O)O-cycloaliphatic, —O—C(O)O-substituted cycloaliphatic, —O—C(O)O-heteroaryl, —O—C(O)O-substituted heteroaryl, —O—C(O)O-heterocyclyl, and —O—C(O)O-substituted heterocyclyl. This group may also be generally referred to in the art as a carbonate.

Oxy(cycloaliphatic): —O-cycloaliphatic.

Oxyheteroaryl: —O-heteroaryl.

Oxyheterocyclyl: —O-heterocycyl.

Phosphine: —PR^{a}₃.

Phosphonate: —P(O)(OR^{a})₂, wherein each R^{a} independently is as defined herein.

Substituted: A fundamental functional group as provided herein, such as an aryl or aliphatic group, or a radical thereof, having coupled thereto, typically in place of a hydrogen atom, a second substituent. Examples of a second substituent include, but are not limited to, alkoxy, acyl, carbonylamino, carboxyester, oxy(carboxyester), oxyacyl, amino(carboxyester), amino, aminoacyl, aminocarbonylamino, oxycarbonylamino, aminosulfonyl, aryl, oxyaryl, thioaryl, carboxyl, cyano, cycloaliphatic, oxycycloaliphatic (—O-cycloaliphatic), thiocycloaliphatic (—S-cycloaliphatic), halogen (e.g., Br, Cl, F, I), hydroxy, heteroaryl, oxyheteroaryl, thioheteroaryl, heterocyclic, oxyheterocyclyl, thioheterocyclyl, nitro, SO₃H, sulfonylamino, sulfonyl, sulfoxide, carbonylthio, thioacyl, thiol, and thioaliphatic. The fundamental functional group typically may be substituted with from 1 to 5 of these substituents.

Sulfonyl: —SO₂-aliphatic, —SO₂-substituted aliphatic, —SO₂-cycloaliphatic, —SO₂-substituted cycloaliphatic, —SO₂-aryl, —SO₂-substituted aryl, —SO₂-heteroaryl, —SO₂-substituted heteroaryl, —SO₂-heterocyclyl, and —SO₂-substituted heterocyclyl.

Sulfonylamino: —SO₂N(R^{b})₂, wherein each R^{b} independently is as defined herein.

Sulfoxide: —S(O)-aliphatic, —S(O)-substituted aliphatic, —S(O)-cycloaliphatic, —S(O)-substituted cycloaliphatic, —S(O)-aryl, —S(O)-substituted aryl, —S(O)-heteroaryl, —S(O)-substituted heteroaryl, —S(O)-heterocyclyl, and —S(O)-substituted heterocyclyl.

Surface ligand: A ligand that may be coupled to a nanoparticle to promote solubility of the nanoparticle.

Surface exchange ligand: A ligand that may be used to further functionalize a nanoparticle by replacing one or more surface ligands bound to the nanoparticle.

Thioaryl: —SC(O)aliphatic, wherein aliphatic is as defined herein.

Thioaliphatic: —S-aliphatic, wherein aliphatic is as defined herein.

Thioaryl: —S-aryl, wherein aryl is as defined herein.

Thio(cycloaliphatic): —S-cycloaliphatic.

Thioheteroaryl: —S-heteroaryl. This term also encompasses oxidized forms of sulfur, such as —S(O)-heteroaryl, or —S(O)₂-heteoaryl.

Thioheterocyclyl: —S-heterocycyl. This term also encompasses oxidized forms of sulfur, such as —S(O)-heterocyclyl, or —S(O)₂-heterocyclyl.

Thiol: —SH.

Thiocarbonyl: (═S).

### II. Nanoparticles

Disclosed herein are nanoparticles that may be functionalized with one or more surface ligands, surface exchange ligands, and combinations thereof. Typically, the nanoparticle has a core which may be functionalized with one or more of the ligands disclosed herein, but in some embodiments, the nanoparticle may be a core-shell nanoparticle, or doped derivatives thereof. Generally, the nanoparticle is synthesized in the presence of a ligand compound, as disclosed herein.

A. Nanoparticle Component

The nanoparticle is selected to have a size suitable for inclusion into nanocomposites that allow light of a particular wavelength to be transmitted without light scattering. The nanoparticle typically may have a diameter ranging from about 2 nm to about 50 nm, with certain embodiments ranging from about 2 nm to about 40 nm, about 2 nm to about 30 nm, about 2 nm to about 20 nm, about 2 nm to about 15 nm, or about 2 nm to about 10 nm. In exemplary embodiments, the nanoparticle typically has a diameter ranging from about 2 nm to about 15 nm. In particular disclosed embodiments, the nanoparticle may be in the shape of a sphere, a spheroid, a cylinder, or an ellipsoid.

In particular disclosed embodiments, the nanoparticle is made of a material that has a high refractive index. The material may be a metal, mixed metal system, or ceramic, and combinations of different nanoparticles may be used. For example, the nanoparticle may comprise a core, such as a quantum dot, and a shell, such as a semiconducting material. Exemplary nanoparticles include, but are not limited to BaTiO₃, SiC, CdTe, Si, ZnTe, PbS, ZnS, Ge, MoSi₂, MoS₂, GaAs, InP, Fe₂O₃, Fe₃O₄, TiO₂, ZrO₂, ZrSiO₄, Al₂O₃, MgAl₂O₄, SiO₂, ZnO, LiF₃, LaBr₃, YVO₄, YVBO₄, CdSe, PbSe, InSb, nanodiamond, and GaP. In particular disclosed embodiments, the nanoparticle is a metal sulfide nanoparticle, such as PbS, ZnS, or MoS₂, that provides transmission in the UV infrared and visible spectral ranges. In particular disclosed embodiments, the nanoparticle is selected to be other than a metal oxide, such as alumina, zirconia, titania, or mixtures/mixed oxides thereof.

B. Ligand Component

In particular disclosed embodiments, a surface ligand may be used to functionalize the nanoparticle core via the core's surface (or shell, if a core-shell nanoparticle is involved) to achieve a desired stability, solubility, and/or reactivity. The surface ligand typically is selected to provide improved solubility in one or more of the polymerizable components disclosed herein. By improving the nanoparticle's solubility, the surface ligands can prevent the nanoparticles from agglomerating.

Surface ligands couple to the nanoparticle and help inhibit aggregation, and also promote dissolution of the nanoparticle into a solution. The surface ligand typically comprises a functional group capable of coupling with the nanoparticle surface. The nanoparticle-ligand interaction may be electrostatic, coordinate, or covalent. In particular disclosed embodiments, the functional group capable of coupling with the nanoparticle surface may be selected from carboxyl, carbonylamino, carbonylthio, carbonylhydrazide, amino, hydroxyl, thiol, hydrazide, phosphonate, and phosphine.

In certain disclosed embodiments, the surface ligand may comprise a non-polar portion. In these embodiments, the non-polar portion may be selected from an aliphatic group, such as C₁₋₄₀alkyl, C₂₋₄₀alkenyl, C₂₋₄₀alkynyl; a cycloaliphatic group, such as C₃₋₁₀cycloalkyl, and C₄₋₁₀cycloalkenyl; and an aromatic group, such as C₆₋₁₄aryl.

In particular disclosed embodiments, the surface ligand may have a formula as provided below.

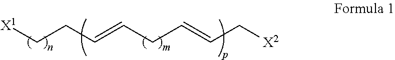

With reference to Formula 1, each of X¹ and X² independently may be selected from hydrogen, methyl, carboxyl, carbonylamino, carbonylthio, carbonylhydrazide, amino, hydroxyl, thiol, hydrazide, phosphonate, and phosphine; n may range from 0 to about 38; m may be 0, 1, 2, or 3; and p may be 0, 1, 2, 3, 4, 5, or 6. In particular disclosed embodiments, p is zero, X¹ is carboxyl, and X² is methyl. In yet further embodiments, p is zero, X¹ is thiol, and X² is methyl. In yet other embodiments, p is zero, X¹ is hydroxyl, and X² is thiol. Exemplary surface ligands include, but are not limited to, fatty acids and thiols. Fatty acids include monounsaturated and polyunsaturated fatty acids, which may be short-chain, medium-chain or long-chain fatty acids.

In particular disclosed embodiments, the surface ligand may have a formula 2, illustrated below, wherein the C₄₋₁₂aliphatic group may be a saturated alkyl group or an unsaturated alkenyl group, and Z is selected from thiol or carboxyl.

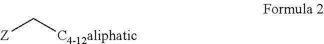

In exemplary embodiments, the surface ligand may be a fatty acid may be selected from myristoleic acid, palmitoleic acid, sapienic acid, oleic acid, elaidic acid, linoleic acid, arachidonic acid, lauric acid, myristic acid, palmitic acid, stearic acid, arachidic acid, and the like. Thiol surface ligands include thiol-terminated hydrocarbon chains, such as octadecanethiol, dodecanethiol, decanethiol, hexadecanethiol, and the like.

In particular disclosed embodiments, the surface ligand may be a bidentate ligand having one of the formulas provided below.

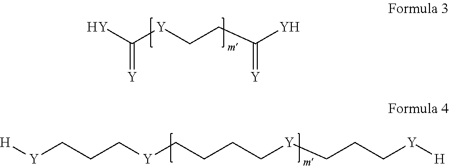

With reference to Formulas 3 and 4, each Y independently may be selected from oxygen, sulfur, and NR² wherein R² may be selected from hydrogen, aliphatic (such as alkyl, substituted alkyl, alkenyl, substituted alkenyl, alkynyl, substituted alkynyl), aryl, substituted aryl, cycloaliphatic (such as cycloalkyl, substituted cycloalkyl, cycloalkenyl, substituted cycloalkenyl, cycloalkynyl, and substituted cycloalkynyl); and each m′ independently may be selected from 1 to about 20, or from 1 to about 15, or from 1 to about 12, or from 1 to about 10, or from 1 to about 5. In exemplary embodiments, the bidentate ligand may be selected from amine-terminated polytetrahydrofuran, carboxy terminated polyethylene glycol, thiol terminated analogs, and the like.

In particular disclosed embodiments, the surface ligand may further comprise one or more additional functional groups capable of imparting compatibility with the polymerizable components disclosed herein. For example, the surface ligand may comprise a polar portion in addition to the functional group capable of coupling to the nanoparticle. The polar portion may be a terminal functional group selected from oxyacyl, aminoacyl, thioacyl, oxyacryloyl, aminoacryloyl, thioacryloyl, hydroxyl, thiol, and amino. In particular disclosed embodiments, the ligand may comprise a hydrocarbon chain that links the functional groups capable of coupling to with the nanoparticle and the polar portion. The length of this hydrocarbon chain can be substantially similar to that of a hydrocarbon chain present in the polymerizable component. Solely by way of example, the hydrocarbon chain may have two fewer (or two more) carbon atoms than the polymerizable component. So, in this example, if the polymerizable component comprises a hydrocarbon chain of six carbon atoms, then the surface ligand used to functionalize the nanoparticle typically is selected to have a hydrocarbon chain of anywhere from about four carbon atoms to about eight carbon atoms; more typically five carbon atoms to seven carbon atoms; more typically six carbon atoms. While the length of the hydrocarbon chains of the polymerizable component and the surface ligand may be substantially similar, this feature is not required.

In particular disclosed embodiments, the surface ligand is a monodentate ligand having a Formula 5 as illustrated below.

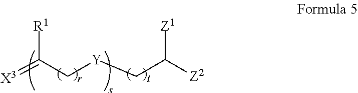

With reference to Formula 5, R¹ may be selected from hydrogen, alkyl, substituted alkyl, alkenyl, substituted alkenyl, alkynyl, substituted alkynyl, aryl, substituted aryl, cycloalkyl, and substituted cycloalkyl; Y may be selected from oxygen, sulfur, NR² wherein R² may be selected from hydrogen, alkyl, substituted alkyl, alkenyl, substituted alkenyl, alkynyl, substituted alkynyl, aryl, substituted aryl, cycloalkyl, and substituted cycloalkyl; X³ may be selected from oxygen, sulfur, NR², hydroxyl, thio, and N(R²)₂ wherein each R² independently is selected from hydrogen, alkyl, substituted alkyl, alkenyl, substituted alkenyl, alkynyl, substituted alkynyl, aryl, substituted aryl, cycloalkyl, and substituted cycloalkyl; Z¹ may be selected from carboxyl, carbonylamino, carbonylthio, carbonylhydrazide, amino, hydroxyl, thiol, hydrazide, phosphonate, and phosphine; Z² may be selected from hydrogen, hydroxyl, alkoxy, amino, thiol, and thioether; r may be 0, 1, 2, or 3; and s and t independently may range from 0 to 20.

In particular disclosed embodiments, the ligand may have a formula according to either Formula 6 or 7, provided below.

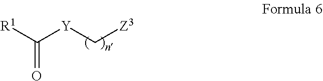

With reference to Formula 6, R¹ may be selected from hydrogen, alkyl, substituted alkyl, alkenyl, substituted alkenyl, alkynyl, substituted alkynyl, aryl, substituted aryl, cycloalkyl, and substituted cycloalkyl; Y may be selected from oxygen, sulfur, NR² wherein R² may be selected from hydrogen, alkyl, substituted alkyl, alkenyl, substituted alkenyl, alkynyl, substituted alkynyl, aryl, substituted aryl, cycloalkyl, and substituted cycloalkyl; Z³ may be selected from carboxyl, carbonylamino, carbonylthio, carbonylhydrazide, amino, hydroxyl, thiol, hydrazide, phosphonate, and phosphine; and n may range from 1 to 20; more typically n′ ranges from 1 to 12; even more typically from 1 to 10; even more typically from 1 to 6. In particular disclosed embodiments, R¹ may be selected from alkenyl and alkynyl and thereby provide an olefin (or (meth)acrylate) suitable for polymerization. In particular disclosed embodiments, the surface ligand is capable of polymerizing and therefore the nanoparticle can be covalently incorporated directly into a polymer matrix. In other embodiments, the nanoparticle is not covalently incorporated into the polymer matrix, but rather is dispersed in the polymer matrix.

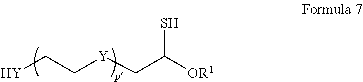

With reference to Formula 7, R¹ may be selected from hydrogen, alkyl, substituted alkyl, alkenyl, substituted alkenyl, alkynyl, substituted alkynyl, aryl, substituted aryl, cycloalkyl, and substituted cycloalkyl; each Y may be selected from oxygen, sulfur, NR² wherein R² may be selected from hydrogen, alkyl, substituted alkyl, alkenyl, substituted alkenyl, alkynyl, substituted alkynyl, aryl, substituted aryl, cycloalkyl, and substituted cycloalkyl; and p′ may range from 1 to 20.

In particular disclosed embodiments, R¹ may be selected from alkenyl, alkynyl, acryloyl (or (meth)acryloyl) and thereby provide an olefin or acrylate (or (meth)acrylate) suitable for polymerization. In these embodiments, the surface ligand is capable of polymerizing and therefore the nanoparticle can be covalently incorporated directly into a polymer matrix. In other embodiments, the nanoparticle is not covalently incorporated into the polymer matrix, but rather is dispersed in the polymer matrix.

In certain disclosed embodiments, the surface ligand may be a mercaptoalcohol. For example, the surface ligand may be selected from mercaptoethanol, 3-mercapto-1-propanol, 4-mercapto-1-butanol, 5-mercapto-1-pentanol, 6-mercapto-1-hexanol, 7-mercapto-1-heptanol, 8-mercapto-1-octanol, 9-mercapto-1-nonanol, 10-mercapto-1-decanol, 11-mercapto-1-undecanol, 12-mercapto-1-dodecanol, and other α-mercapto-ω-alcohols having from about 1 to about 20 carbon atoms, and combinations thereof. In particular disclosed embodiments, the nanoparticle is resistant to aggregation for extended periods of time both in solution and the dry solid state. Typically, metal-sulfide nanoparticles are functionalized with these types of surface ligands, but the present disclosure is not limited to this combination.

Other exemplary surface ligands include, but are not limited to, 6-acetoxyhexanoic acid (AHA), 4-aceteoxybutanoic acid (ABA), acetoxyacetic acid (AAA), 6-acetoxy-1-hexanethiol (6AHT), 2-acetoxy-1-ethanethiol (AET), 4-acetoxy-1-butanethiol (ABT), 6-acryloyloxy-1-hexanethiol (6ACRYLHT), 2-acryloyloxy-1-ethanethiol (ACRYLET), 6-propionyloxy-1-hexanethiol (6PHT), 2-propionyloxy-1-ethanethiol (PET), 4-propionyloxy-1-butanethiol (PBT), 6-butyryloxy-1-hexanethiol (6BHT), 2-butyryloxy-1-ethanethiol (BET), 4-butyryloxy-1-butanethiol (BBT) 6-isobutyryloxy-1-hexanethiol (6iBHT), 2-isobutyryloxy-1-ethanethiol (iBET), 4-isobutyryloxy-1-butanethiol (iBBT), 6-tert-butyryloxy-1-hexanethiol (6tBHT), 2-tert-butyryloxy-1-ethanethiol (tBET), 4-tert-butyryloxy-1-butanethiol (tBBT), 2-(propionyloxy)acetic acid, 2-(butyryloxy)acetic acid, 2-(isobutyryloxy)acetic acid, 2-(pivaloyloxy)acetic acid, 2-(pentanoyloxy)acetic acid, 2-(hexanoyloxy)acetic acid, 3-(hexanoyloxy)propanoic acid, 3-(pentanoyloxy)propanoic acid, 3-(butyryloxy)propanoic acid, 3-(pivaloyloxy)propanoic acid, 3-(isobutyryloxy)propanoic acid, 3-(propionyloxy)propanoic acid, 3-(acetoxy)propanoic acid, 4-(acetoxy)butanoic acid, 4-(propionyloxy)butanoic acid, 4-(butyryloxy)butanoic acid, 4-(isobutyryloxy)butanoic acid, 4-(pivaloyloxy)butanoic acid, 4-(pentanoyloxy)butanoic acid, 4-(hexanoyloxy)butanoic acid, 5-(acetoxy)pentanoic, 5-(propionyloxy)pentanoic acid, 5-(butyryloxy)pentanoic acid, 5-(isobutyryloxy)pentanoic acid, 5-(pivaloyloxy)pentanoic acid, 5-(pentanoyloxy)pentanoic acid, 5-(hexanoyloxy)pentanoic acid, 6-(propionyloxy)hexanoic acid, 6-(butyryloxy)hexanoic acid, 6-(isobutyryloxy)hexanoic acid, 6-(pivaloyloxy)hexanoic acid, 6-(pentanoyloxy)hexanoic acid, 6-(hexanoyloxy)hexanoic acid, 7-(hexanoyloxy)heptanoic acid, 7-(pentanoyloxy)heptanoic acid, 7-(butyryloxy)heptanoic acid, 7-(isobutyryloxy)heptanoic acid, 7-(pivaloyloxy)heptanoic acid, 7-(propionyloxy)heptanoic acid, 7-(acetoxy)heptanoic acid 6-(acryloyloxy)hexanoic acid, 6-(methacryloyloxy)hexanoic acid, 4-(acryloyloxy)butanoic acid, 4-(methacryloyloxy)butanoic acid, (acryloyloxy)acetic acid, (methacryloyloxy)acetic acid, 7-(acryloyloxy)heptanoic acid, 7-(methacryloxy)heptanoic acid, 5-(acryloyloxy)pentanoic acid, 5-(methacryloyloxy)pentanoic acid, diethylene glycol monomethyl ether thiol, triethylene glycol monomethyl ether thiol, tetraethylene glycol monomethyl ether thiol, low molecular weight olio-ethylene glycol monomethyl ether thiol, benzenethiol, toluenethiol, and alkylthiolbenzenes.

In particular disclosed embodiments, the surface ligand may be synthesized using a method illustrated in any one of Schemes 1 and 2.

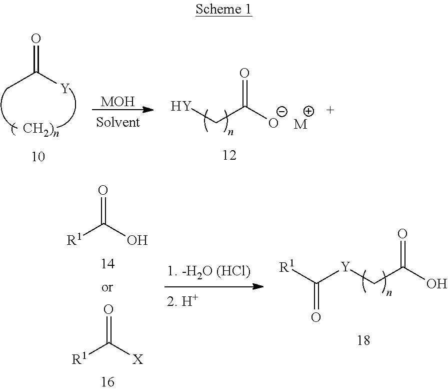

With reference to Scheme 1, Y is selected from oxygen, sulfur, or NR² wherein R² is selected from hydrogen, alkyl, substituted alkyl, alkenyl, substituted alkenyl, alkynyl, substituted alkynyl, aryl, substituted aryl, cycloalkyl, and substituted cycloalkyl; and n is as provided herein. Variable “X” may be a leaving group selected from halogen (e.g., chloro, bromo, iodo, and fluoro), a mesyl group (—OMs), a tosyl group (—OTs), a besyl group (—OBs), a triflate group (—OTf) and the like; M may be a metal, such as a Group I metal, selected from potassium, sodium, lithium, and the like. The solvent typically is a protic, polar solvent, such as methanol, ethanol, isopropanol, butanol, and the like. In particular embodiments, a cyclic starting material 10 undergoes base-mediated ring opening to provide compound 12. This compound may then be combined with either a suitable carboxylic acid derivative 14 and undergo acid-catalyzed esterification to provide the desired ligand 18. Alternatively, compound 12 can be combined with carbonyl-containing compound 16, wherein a base may be used to drive this reaction to completion, particularly when the carbonyl-containing compound 16 is an acid halide.

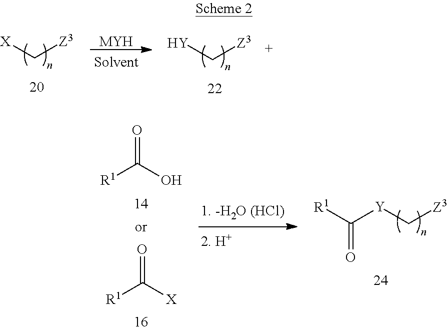

With reference to Scheme 2, Y, X, and n are as provided for Scheme 1, and Z³ is as disclosed herein. According to Scheme 2, starting material 20 is converted to intermediate 22, which is then converted to the desired ligand 24 via acid-catalyzed esterification with carboxylic acid derivative 14 or a base-driven reaction with carbonyl-containing compound 16, using similar conditions as those provided in Scheme 1.

An exemplary method of synthesizing the surface ligand is illustrated in Scheme 3, below. With reference to Scheme 3, the starting material, ε-caprolactone 30, undergoes ring opening upon base addition, thereby providing the open-chained salt compound 32. The resulting salt may then undergo acid-catalyzed esterification with acetic acid (34) to provide surface ligand 36.

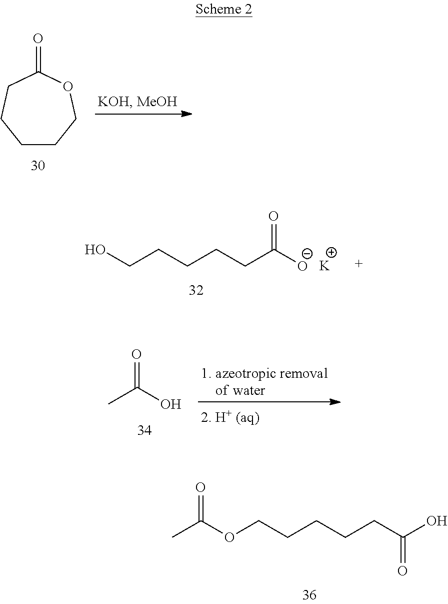

In other exemplary embodiments, the surface ligand may be synthesized using the method illustrated in Scheme 4, below. With reference to Scheme 4, acyclic starting material 40 may be treated with KOH in methanol to provide salt 42. This salt may then undergo acid-catalyzed esterification with an appropriate acid (44), or acid chloride (46), as illustrated in Scheme 4 to provide the desired surface ligand 48.

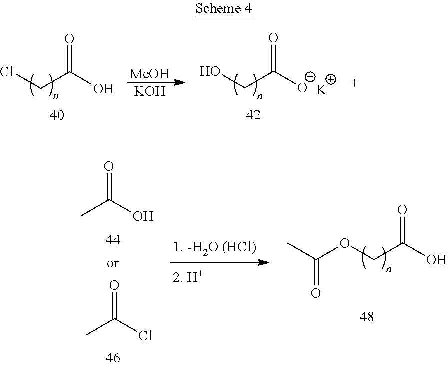

### III. Polymerizable Component

Disclosed herein are embodiments of a polymerizable component that is suitable for acting as a medium for depositing the disclosed functionalized nanoparticles in order to provide optical materials having specific refractive index variations. In particular disclosed embodiments, the polymerizable component is a high clarity, low viscosity monomer that is capable of being cured. Polymerizable component selection also may be made based on the refractive index of the particular material and/or the viscosity of the material. In particular disclosed embodiments, the refractive index may range from about 1.2 to about 1.8, with particular disclosed embodiments having a refractive index of about 1.45 to about 1.55. The polymerizable component also may have a viscosity ranging from about 5 cP to about 20 cP, from about 10 cP to about 20 cP, or from about 10 cP to about 15 cP. In particular disclosed embodiments, the temperature used for deposition may be adjusted in order to deposit polymerizable component materials (with or without addition of the disclosed nanoparticles) that have higher viscosity at room temperature (which can typically range from about 20° C. to about 25° C.). For example, the temperature may be increased to about 10° C. to about 60° C. above room temperature. The temperature therefore may range from about 20° C. to about 80° C., or from about 20° C. to about 75° C., or from about 20° C. to about 70° C., or from about 35° C. to about 70° C.

In particular disclosed embodiments, the polymerizable component comprises one or more moieties that can undergo polymerization, such as an olefin, acrylate (or substituted acrylate), and a C₂heterocyclyl (e.g., epoxides, aziridines, and the like). The selected polymerizable component may be one compound, or may comprise a mixture of various different compounds (such as a comonomer or copolymer).

An acrylate moiety comprises a carbonyl group and a polymerizable olefinic portion. The acrylate may be substituted with one or more alkyl groups (e.g., methyl, ethyl, propyl, butyl, etc.). In particular disclosed embodiments, the polymerizable component is a monomer that comprises 1 to 4 acrylate moieties. The monomer also may comprise a mixture of monomers having a different number of arylate groups or other functional groups.

In particular disclosed embodiments, the polymerizable component comprises an aliphatic chain. For example, the polymerizable component may be a monomer comprising an aliphatic chain of from 1 to about 30 carbon atoms; more typically from 1 to about 20 carbon atoms; even more typically from 1 to about 15 carbon atoms. In exemplary embodiments, the monomer comprises an alkyl chain of 2 to 10 carbon atoms; or from 2 to 6 carbon atoms.

Exemplary polymerizable components include, but are not limited to, hexanediol-diacrylate (HDDA), methyl acrylate, ethyl acrylate, butyl acrylate, isobutyl acrylate, tert-butyl acrylate, n-hexyl acrylate, ethylhexyl acrylate, n-octyl acrylate, isooctyl acrylate, n-decyl acrylate, n-dodecyl acrylate, n-hexadecyl acrylate, n-octadecyl acrylate, isobornyl acrylate, benzyl acrylate, phenyl acrylate, low molecular weight oligio-ethylene glycol monomethyl ether acrylate, ethylene glycol monomethyl ether acrylate, diethyleneglycol monomethyl ether acrylate, triethylene glycol monomethyl ether acrylate, tetraethylene glycol monomethyl ether acrylate, diethylene glycol diacrylate, triethylene glycol diacrylate, tetraethylene glycol diacrylate, low molecular weight oligio-ethylene glycol diacrylate, trimethylolpropane triacrylate, pentaerythritol tetraacrylate, neopentyl glycol diacrylate (2,2-dimethyl-1,3-propanediol diacrylate), 1,10-decanediol diacrylate, hexanediol-dimethacrylate, ethyl methacrylate, butyl methacrylate, isobutyl methacrylate, tert-butyl methacrylate, n-hexyl methacrylate, ethylhexyl methacrylate, n-octyl metacrylate, isooctyl methacrylate, n-decyl methacrylate, n-dodecyl methacrylate, n-hexadecyl methacrylate, n-octadecyl methacrylate, benzyl methacrylate, phenyl methacrylate, low molecular weight oligio-ethylene glycol monomethyl ether methacrylate, ethylene glycol monomethyl ether methacrylate, diethyleneglycol monomethyl ether methacrylate, triethylene glycol monomethyl ether methacrylate, tetraethylene glycol monomethyl ether methacrylate, diethylene glycol dimethacrylate, triethylene glycol dimethacrylate, tetraethylene glycol dimethacrylate, low molecular weight oligio-ethylene glycol dimethacrylate, trimethylolpropane trimethacrylate, pentaerythritol tetramethacrylate, neopentyl glycol dimethacrylate (2,2-dimethyl-1,3-propanediol dimethacrylate), 1,10-decanediol dimethacrylate, and combinations thereof.

The polymerizable component disclosed herein is capable of being cured to form a polymer, or to polymerize further. The cured polymer is suitable for use in optical element fabrication. The polymerizable component may be cured when exposed to an energy source, such as a UV or visible light source. In particular disclosed embodiments, a UV LED light source is used. Additionally, the curing step can be conducted under an inert atmosphere (e.g., applying a flow of inert gas, such as argon, nitrogen, and the like) so as to prevent oxygen-mediated inhibition of the curing reaction. The monomer typically is cured after the functionalized nanoparticles have been embedded, dispersed, or covalently integrated in the polymerizable component. In particular disclosed embodiments, small incremental doses of energy (e.g., UV light) are provided thereby allowing the polymerizable component to cure slowly so as to mitigate shrinkage.

In particular disclosed embodiments, the polymerizable component may be cured in the presence of a photoinitiator. A desirable property of the photoinitiator is that it does not contribute to or cause yellowing of the cured material obtained during the curing process. Examples of suitable photoinitiators include, but are not limited to 1-hydroxy-cyclohexyl-phenyl ketone, benzophenone, 2,2-dimethoxy-1,2-diphenylethan-1-one, 1-[4-(2-hydroxyethoxy)-phenyl]-2-hydroxy-2-methyl-1-propane-1-one, 1-hydroxy-cyclohexyl-phenyl-ketone, 2-benzyl-2-dimethylamino-1-(4-morpholinophenyl)-butanone, bis(eta-5-2,4-cylcopentadien-1-yl)-bis(2,6-difluoro-3-(1H-pyrrol-1-yl)-phenyl) titanium, bis(2,4,6-trimethylbenzoyl)-phenylphosphineoxide, bis(2,6-dimethoxybenzoyl)-2,4,4-trimethyl pentylphosphineoxide, 2-hydroxy-2-methyl-1-phenyl-propan-1-one, 2-hydroxy-2-methyl-1-phenyl-propan-1-one-2,4,6-trimethylbenzoyldiphenyl-phosphine oxide, and combinations thereof.

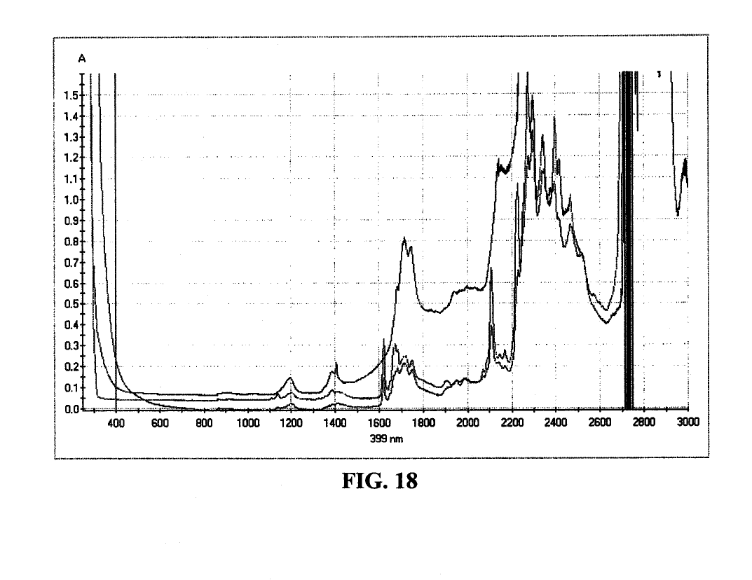

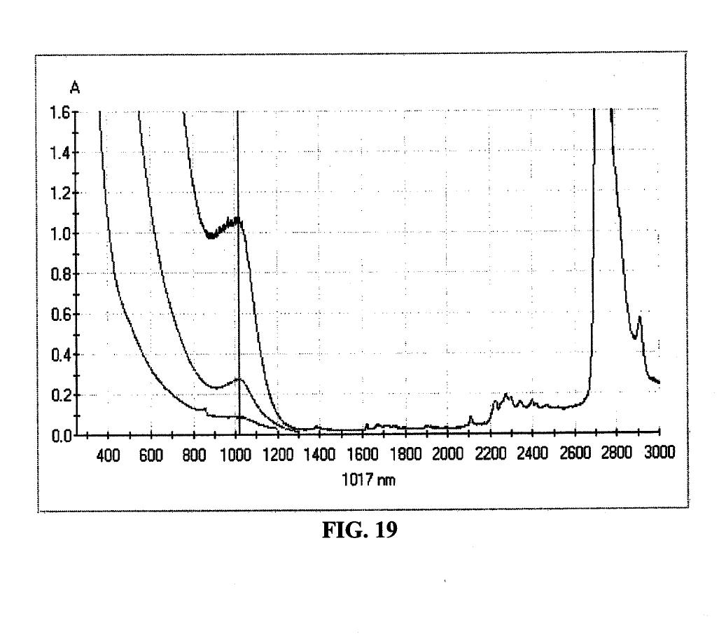

Also disclosed herein are methods for determining incorporation of the functionalized nanoparticle into the polymerizable component. In particular disclosed embodiments, UV and infrared (IR) spectroscopy are used to analyze the dispersion of the nanoparticles in the polymerizable component, as well dispersed embodiments will have good light transmission. FIGS. 18 and 19 illustrate results obtained from analyzing a thin film of the monomer and dispersed nanoparticles. FIG. 18 is an IR spectrum (measured in absorbance) obtained from a film (1 mm thickness) of AHA-functionalized ZnS nanoparticles (50%) in HDDA. FIG. 19 is an IR spectrum (measured in absorbance) obtained from a film (0.1 mm thickness) of AHA-functionalized PbS nanoparticles (30%) in HDDA.

The surface ligands disclosed herein promote the nanoparticle's ability to exhibit increased solubility in solvents, monomers, and polymers disclosed herein and therefore allow for high concentrations of the functionalized nanoparticle to be dispersed in these components. In particular disclosed embodiments, the concentration of the functionalized nanoparticle may range from about 1% wt/v to about 80% wt/v; more typically from about 10% wt/v to about 75% wt/v, about 65% wt/v, about 50% wt/v, or about 40% wt/v.

### IV. Method of Making Functionalized Nanoparticles

Disclosed herein are embodiments of a method for making the functionalized nanoparticles disclosed herein. In particular disclosed embodiments, the functionalized nanoparticles are obtained by either modifying the nanoparticle with a surface ligand during the nanoparticle synthesis or further functionalizing the nanoparticle via a ligand exchange reaction. Further functionalizing, in this context, comprises displacing one or more surface ligands for a different ligand, referred to as a surface exchange ligand. In particular disclosed embodiments, all, or substantially all, of the surface ligands may be displaced. In other embodiments, only a portion of the surface ligands (such as less than 60%, less than 50%, or less than 40%) are displaced by the surface exchange ligands.

A nanoparticle comprising one or more surface ligands may be dissolved in a suitable solvent, such as methylene chloride. A desired surface exchange ligand may then be added to the solution, either neat or as a separate solution. The mixture can then be stirred and/or sonicated for a suitable time. In particular disclosed embodiments, the mixture is sonicated in an ultrasonic bath for anywhere from about 30 minutes to about 2 hours, but a person of ordinary skill in the art would recognize that this time period may be shorter or longer depending on the solvent, the nanoparticle, and the ligand involved. Nanoparticles functionalized with one or more of the surface-exchange ligands may then be isolated by precipitation, such as by adding to the mixture a suitable volume of a non-polar solvent. In particular disclosed embodiments, a 5-fold excess of a non-polar solvent, such as hexane(s), is added to the mixture. The functionalized nanoparticles are then isolated using centrifugation or filtration. The precipitation and isolations steps may be repeated any number of times.

Another method of making the nanoparticle concerns functional group modification of surface ligands attached to the nanoparticle. For example, a nanoparticle may be functionalized with one or more surface ligands that comprise a functional group capable of being chemically modified (that is, a functional group that is not attached to the nanoparticle). In particular disclosed embodiments, the nanoparticle is exposed to a reagent that chemically binds to this functional group. The functional group may be terminal (that is, at the end of the surface ligand) or it may be located internally or at a branched position on the surface ligand. In particular disclosed embodiments, the reagent comprises a carbonyl moiety that becomes bound through a carbon atom of the carbonyl moiety to the functional group of the one or more surface ligands.

The schemes and figure discussed below illustrate particular disclosed embodiments wherein various functionalized nanoparticles are synthesized. An example of a ligand exchange reaction as is disclosed herein is provided below in FIG. 16. With reference to FIG. 16, a PbS nanoparticle functionalized with numerous oleic acid surface ligands is combined with a bidentate polymer, such as amine terminated polytetrahydrofuran (ATHF). The nanoparticle undergoes ligand exchange, during which the oleic acid ligands are displaced by the bidentate polymer ligands to yield a modified nanoparticle comprising surface-exchange ligands.

As another example, Scheme 5 illustrates a ZnS nanoparticle (56) functionalized with numerous mercaptoethanol ligands. This particular embodiment is made by reacting zinc acetate (50) with thiourea (52) and mercaptoethanol (54). An additional embodiment is illustrated in Scheme 6, which illustrates a similar conversion to obtain nanoparticle 60, this particular embodiment using 6-mercapto-1-hexanol (62) rather than mercaptoethanol.

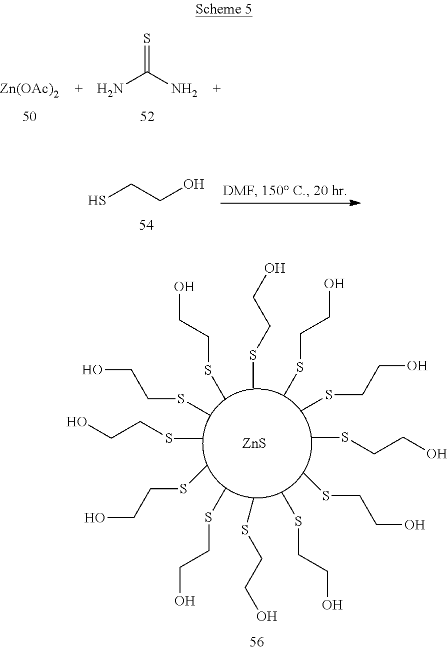

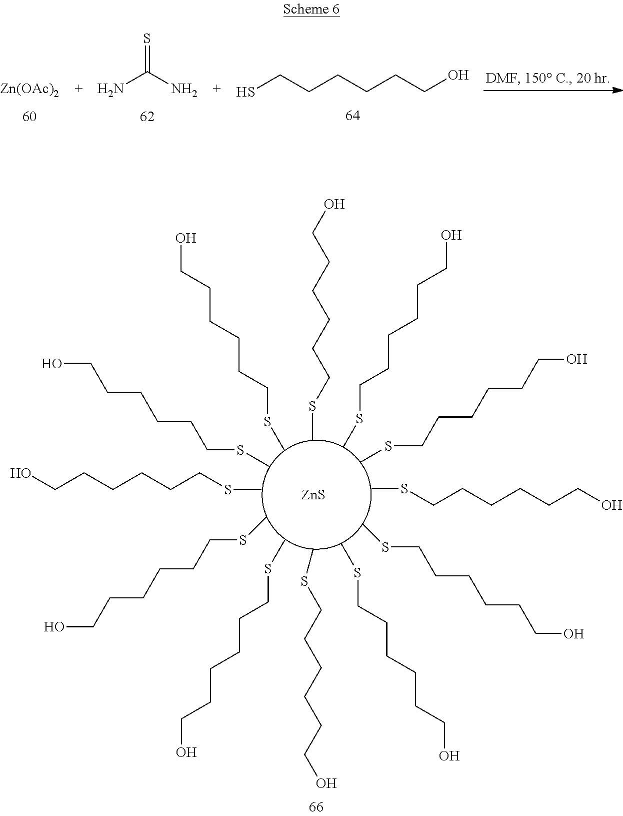

The functionalized nanoparticles can then undergo post-functionalization to provide nanoparticles suitable for use with the disclosed polymerizable component. An exemplary embodiment is provided below in Scheme 7. According to Scheme 7, the mercaptoethanol functionalized ZnS nanoparticle (70) is combined with acetic anhydride to provide an acetoxy-functionalized nanoparticle (72).

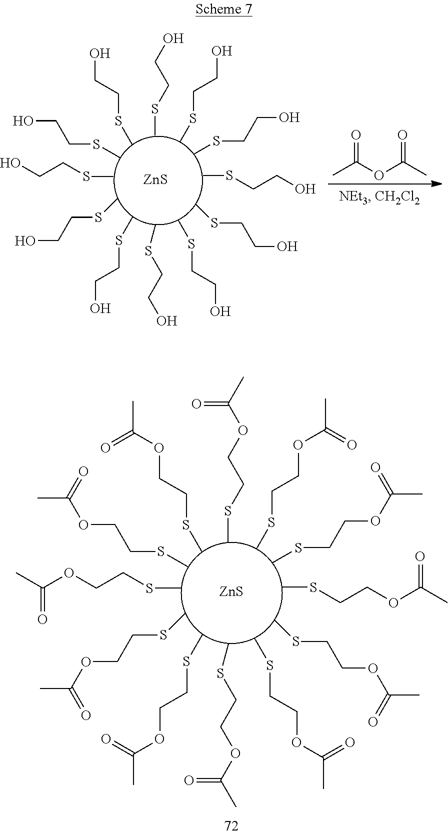

Once the functionalized nanoparticles comprising one or more surface-exchange ligands are isolated, they may be combined with the polymerizable component. In particular disclosed embodiments, the nanoparticles are dissolved in a solution, using an appropriate solvent (e.g., methylene chloride), and the polymerizable component is then added to this solution. In particular disclosed embodiments, the polymerizable component and nanoparticle are combined at room temperature. Sonication may be used, but is not necessary, to promote further dispersion of the functionalized nanoparticles in the polymerizable component. If a solution of the functionalized nanoparticles is used, then the solvent may be removed using methods known to those of ordinary skill in the art, such as evaporation, distillation, and the like. The functionalized nanoparticles need not be added to the polymerizable component as a solution, and instead may be added neat. In particular disclosed embodiments, the functionalized nanoparticles are dispersed in the polymerizable component using a mechanical high-shear homogenizer. The homogenizer may be operated at speeds ranging from about 10,000 rpm to about 30,000 rpm. Such speeds are selected so as to prevent agglomeration of the nanoparticles.

In particular disclosed embodiments, the ligand exchange reaction may be monitored in order to determine the extent of ligand exchange, identify the nature of the ligand shell surrounding the nanoparticle surface/core, and the presence of excess free ligand (surface ligand and/or surface exchange ligand). In certain embodiments, the ligand exchange reaction is monitored using nuclear magnetic resonance techniques, such as ¹H NMR.

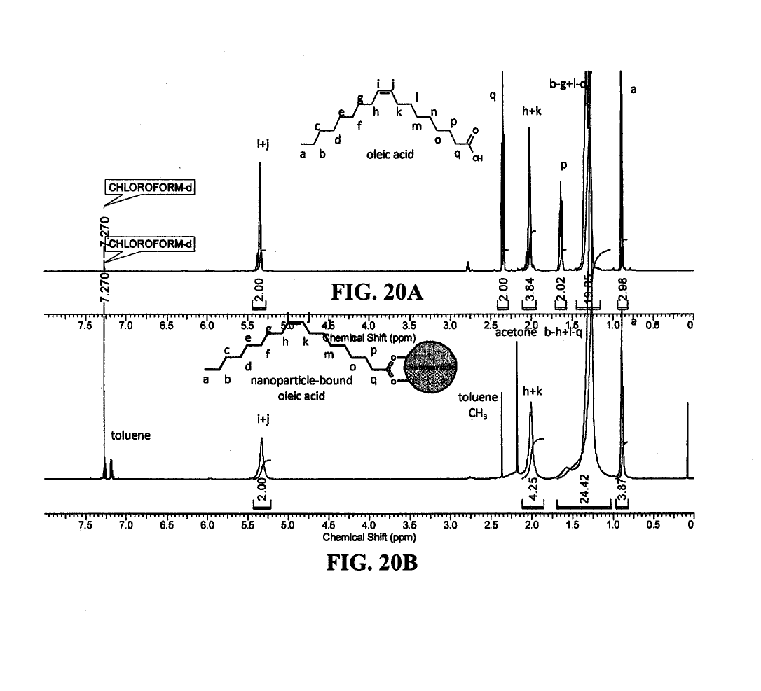

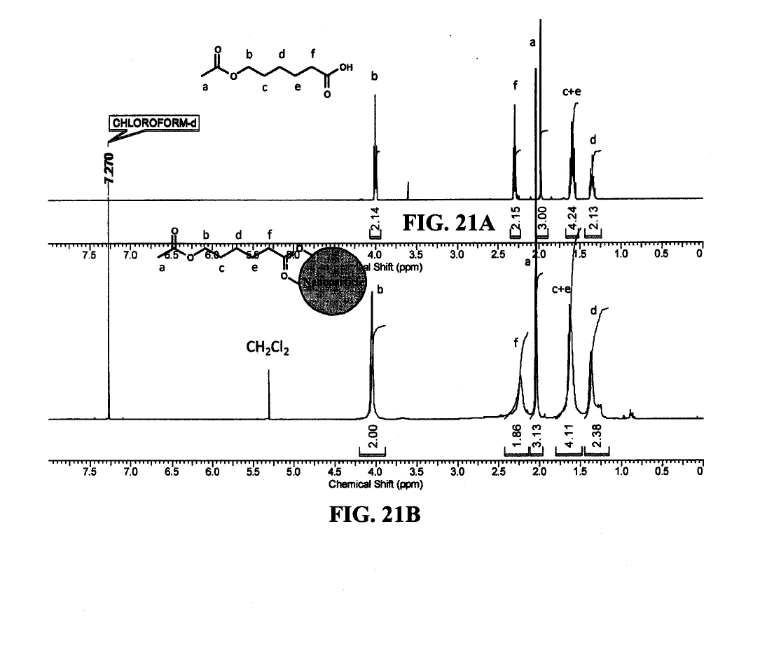

Results from using ¹H NMR spectroscopy to monitor particular disclosed embodiments are illustrated in FIGS. 20A, 20B, 21A, and 21B. FIG. 20A is a representative ¹H NMR spectrum of free oleic acid in CDCl₃. FIG. 20B illustrates results obtained when the nanoparticle is functionalized with a surface ligand, such as oleic acid. Most notable is the broadening of the individual peaks of the oleic acid ligand and the loss of resolved splitting observed in the nanoparticle-containing sample. These features corroborate that the surface ligands are coupled to the nanoparticle.

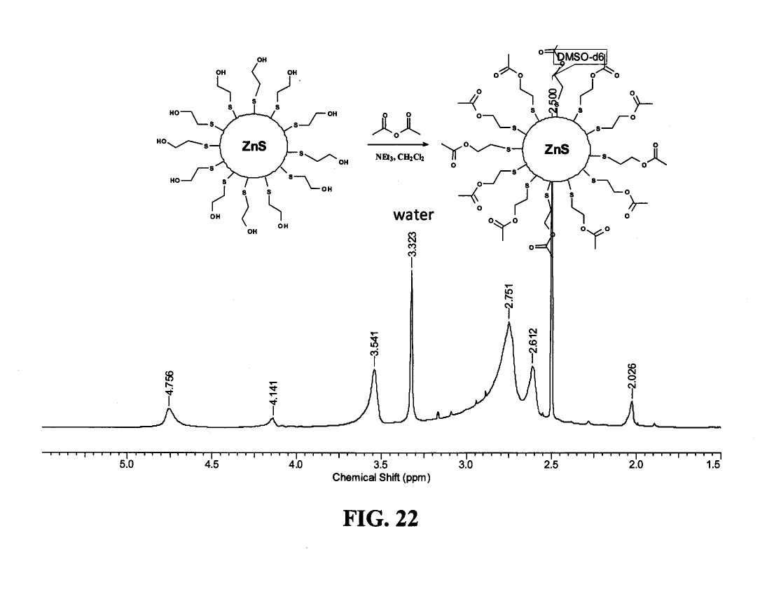

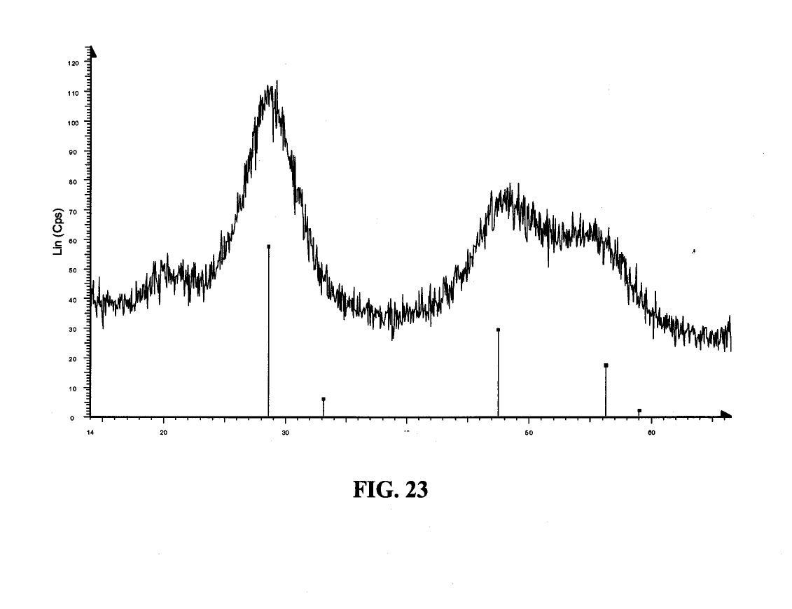

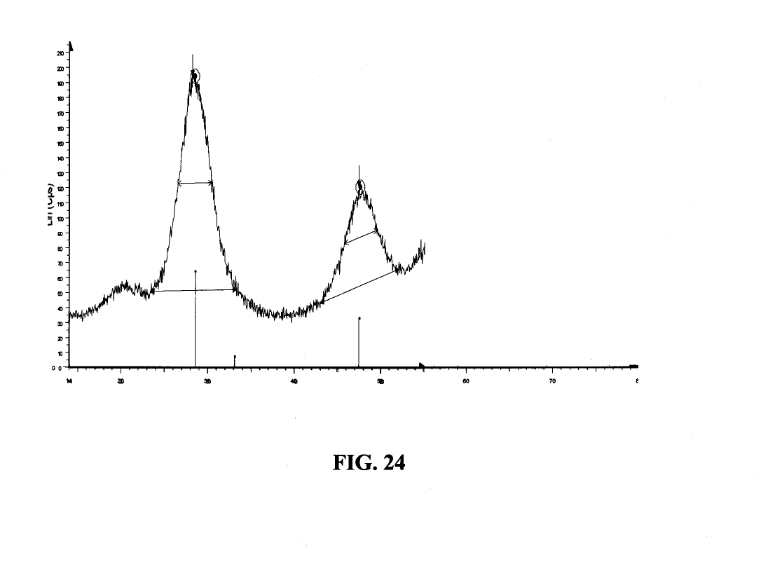

Without being limited to a single theory of operation, it is currently believed that restricting the movements of the oleic acid molecules as well, as shielding, causes particular peaks to collapse into a major peak, whereas peaks that are further away from the functional group that couples the ligand to the nanoparticle since they retain more rotational freedom. A similar effect is observed after ligand exchange of the nanoparticles with the surface exchange ligand. In particular disclosed embodiments, the nanoparticle is a PbS nanoparticle and the surface exchange ligand is 6-acetoxyhexanoic acid. FIGS. 21A and 21B illustrate such an embodiment. FIG. 21A is a representative ¹H NMR spectrum of free 6-acetoxyhexanoic acid in CDCl₃ and FIG. 21B illustrates the spectrum obtained from 6-acetoxyhexanoic acid-stabilized PbS nanoparticles. While the peaks retain their original relative position and integration values, the peaks broaden and change slightly in their chemical shift, thereby indicating that the surface exchange ligands (e.g., acetoxyhexanoic acid ligands) are bound to the nanoparticles. FIG. 22 is a ¹H NMR spectrum of another disclosed embodiment, a ZnS nanoparticle functionalized with mercaptoethanol ligands.

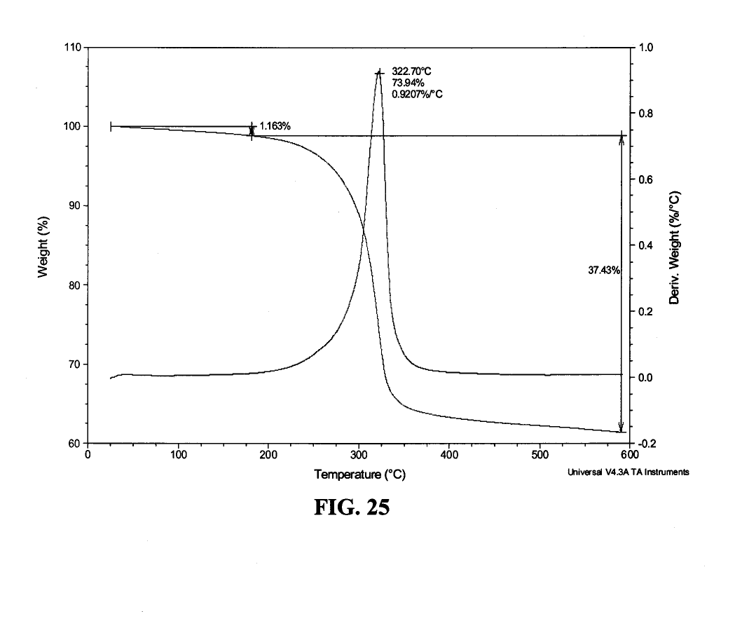

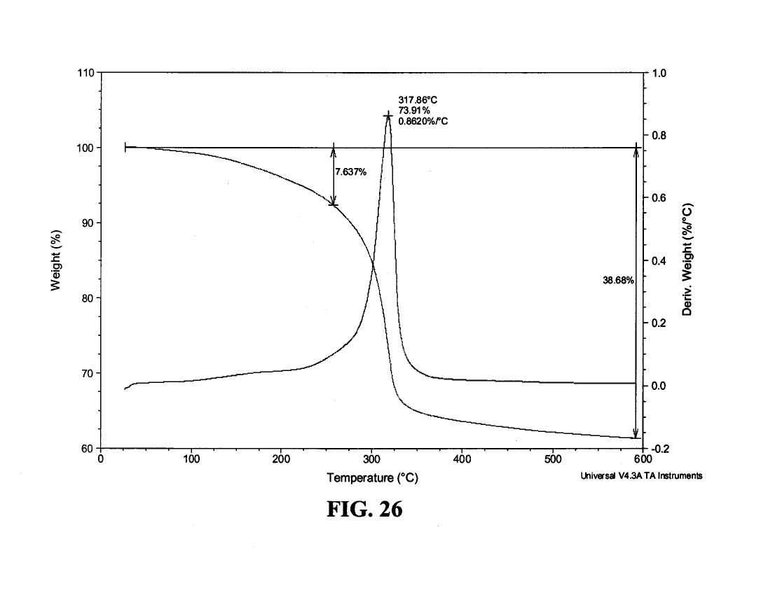

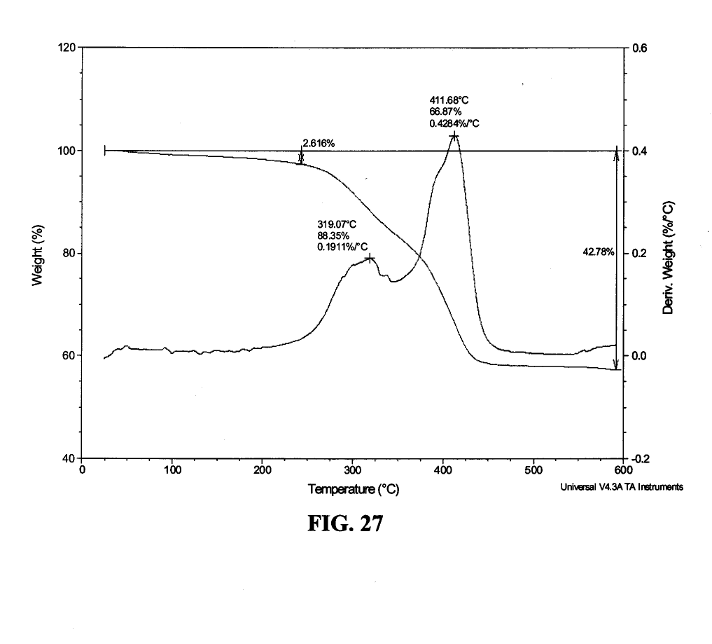

Other methods may be used to determine nanoparticle formation. For example, wide angle x-ray diffraction (WAXD) may be used to identify the nanoparticles after they have undergone ligand exchange. Examples of results obtained using this method are illustrated in FIGS. 23 and 24. FIG. 23 illustrates an X-ray spectrum obtained from a ZnS nanoparticle comprising mercaptoethanol ligands. With reference to FIG. 23, the near merging peaks at 47.8 and 56.3 degrees indicate that the particles, or the crystal domains, are very small. FIG. 24 illustrates a spectrum obtained from a ZnS nanoparticle functionalized with 6-mercapto-1-hexanol ligands. Additional embodiments concern using thermogravimetric analysis to determine the amount of ligand bound to nanoparticles. For example, FIG. 25 is a thermogravimetric analysis plot of a mercaptoethanol-stabilized ZnS nanoparticle, and FIG. 26 is a thermogravimetric analysis plot of the mercaptoethanol-stabilized ZnS nanoparticle after it has been modified with an acetoxy group to provide an acetoxyethanethiol-stabilized ZnS nanoparticle. FIG. 27 further illustrates another embodiment wherein thermogravimetric analysis is used; particularly to identify the amount of ligand bound to a 6-mercapto-1-hexanol-stabilized ZnS nanoparticle.

### V. Working Embodiments

Synthesis of potassium 6-hydroxyhexanoate—Potassium hydroxide (74.53 g, 1.328 mol) was dissolved in 800 mL methanol. ε-Caprolactone (150 mL, 154.5 g, 1.354 mol) was slowly poured into the solution over 2 minutes and allowed to stir for 1 hour at room temperature. Rotary evaporation yielded crude potassium 6-hydroxyhexanoate as an off-white solid. Residual ε-caprolactone and other impurities were removed by stirring the insoluble potassium salt in ethyl ether for 1 hour followed by filtration of the resulting white solid. Final yield of potassium 6-hydroxyhexanoate was 219 g (95% yield).

Synthesis of 6-acetoxyhexanoic acid—Potassium 6-hydroxyhexanoate (100 g, 0.558 mol) was dissolved in glacial acetic acid (800 mL, 839.2 g, 12.9 mol). A Dean-Stark trap was attached to the flask and 100 mL toluene was added to the reaction solution for removal of water by azeotropic distillation. The reaction solution was heated to 130° C. (oil bath temperature) until water was no longer generated. Rotary evaporation was used to remove the toluene and acetic acid. The resulting viscous liquid was partitioned between 10% aqueous HCl and ethyl ether. The aqueous phase was extracted with ethyl ether (3×300 mL) and the combined organic phase was rotary evaporated to yield a yellow viscous liquid. Vacuum distillation at 130° C. (˜200 microns) yielded a colorless oily liquid, which was determined to be pure 6-acetoxyhexanoic acid by ¹H and ¹³CNMR (87.98 g; 88% yield).

Preparation of PbS-AHA coated nanoparticles—lead sulfide nanoparticles with oleic acid ligand surface treatment (PbS-OA) (143 mg PbS-OA; 100 mg PbS without ligand) where dissolved in 10 mL methylene chloride followed by addition of 6-acetoxyhexanoic acid (AHA) (0.75 g, 0.00419 mol; 10× mol PbS). The resulting solution was placed in an ultrasonic bath for 1 hour. PbS-AHA nanoparticles were precipitated by addition of the reaction solution into a 5-fold excess of hexane. The solid was collected by centrifugation to yield a clear, colorless solution and a small quantity of a dark brown oily liquid containing the PbS-AHA and excess ligand. After decanting the clear solution, the resulting PbS-AHA/ligand mixture was dissolved in 5 mL methylene chloride and precipitated a second time in a 5-fold excess of hexane. Centrifugation yielded a dark brown solid, which was dried under vacuum at room temperature. Solid PbS-AHA was dissolved in 10 mL methylene chloride and 1,6-hexanedioldiacrylate (HDODA) was added. The solution was sonicated for 1 hour before removal of methylene chloride by rotary evaporation. The resulting stable, dark transparent brown solution of PbS-AHA in HDODA (1-50% wt/wt) was used for further experimentation.

Preparation of ZnS-ME nanoparticles: Zinc acetate dihydrate (5.46167 g, 0.02488 mol) was placed in a 100 mL 3-neck round bottom flask fitted with a reflux condenser, a septum and a stopper and dissolved in 40 mL DMF. The solution was allowed to purge under a stream of nitrogen for 15 minutes during which time mercaptoethanol (2.6 mL; 2.8964 g, 0.03707 mol) was added by syringe. The solution was purged with nitrogen for 30 minutes followed by addition of thiourea (1.59562 g, 0.02096 mmol) in 10 mL DMF. The solution was heated to 150° C. for 20 hours. The resulting pale yellow, completely transparent solution was allowed to cool to room temperature and the volume was reduced to 20 mL by vacuum distillation. The remaining solution was added slowly to rapidly stirred flask containing 400 mL of ethanol to yield a white precipitate which was collected by centrifugation. Addition of 5 mL DMF yielded a completely clear (no haze or precipitate) syrupy solution, which was precipitated a second time. Centrifugation yielded a white solid which was determined to be ZnS by wide angle x-ray diffraction (WAXD) (Data collected and presented by Dr. Charles Dupuy of Voxtel, Inc). Based on TGA data (FIG. 25) ZnS-ME nanoparticles are ˜37% mercaptoethanol by weight.

Acetoxy-functionalization of mercaptoethanol-stabilized zinc sulfide (ZnS-ME) nanoparticles: (0.4665 g; 0.1726 g, 2.2378 mmol mercaptoethanol) were dispersed in 10 mL CH₂Cl₂ followed by addition of acetic anhydride (0.5 mL; 0.4621 g, 4.5264 mmol). Triethylamine (0.65 mL; 0.4719 g, 4.6635 mmol) was added to the stirred suspension. After 1 hour, the solution became completely transparent. The mixture was stirred for 15 hours at room temperature and poured into 100 mL hexanes to yield a white precipitate which was collected by centrifugation.

Preparation of ZnS-6MCH nanoparticles: Zinc acetate dihydrate (5.4293 g, 0.0247 mol) was placed in a 100 mL 3-neck round bottom flask fitted with a reflux condenser, a septum and a stopper and dissolved in 40 mL DMF. The solution was allowed to purge under a stream of nitrogen for 15 minutes during which time 6-mercapto-1-hexanol (5 mL; 4.905 g, 0.0365 mol) was added by syringe. The solution was heated to 150° C. followed by addition of thiourea (1.59562 g, 0.02096 mmol) in 10 mL DMF. The reaction was allowed to stir at 150° C. for 20 hours. The resulting completely transparent solution was allowed to cool to room temperature and the volume was reduced to 5 mL by vacuum distillation. The remaining solution was added slowly to rapidly stirred flask containing 250 mL of acetone to yield a white precipitate, which was collected by centrifugation. Addition of 5 mL methanol yielded a completely clear (no haze or precipitate) syrupy solution, which was precipitated a second time into acetone. Centrifugation yielded a white solid, which was determined to be ZnS by wide angle x-ray diffraction (WAXD).

In view of the many possible embodiments to which the principles of the disclosed invention may be applied, it should be recognized that the illustrated embodiments are only preferred examples of the invention and should not be taken as limiting the scope of the invention. For example, the above examples are described with reference to varying layer indices of refraction. Absorbing materials such as dyes can also be dispersed in monomers, and gradients in absorption produced as well, with or without gradients in refractive index. We therefore claim as our invention all that comes within the scope and spirit of the appended claims.

1-25. (canceled)

26. A composition, comprising:
a ZrO₂ nanoparticle;
a photoinitiator; and
a monomer selected from hexanediol-diacrylate, methyl acrylate, ethyl acrylate, butyl acrylate, isobutyl acrylate, n-hexyl acrylate, ethylhexyl acrylate, n-octyl acrylate, isobornyl acrylate, ethylene glycol monomethyl ether acrylate, diethyleneglycol monomethyl ether acrylate, triethylene glycol monomethyl ether acrylate, diethylene glycol diacrylate, triethylene glycol diacrylate, tetraethylene glycol diacrylate, neopentyl glycol diacrylate (2,2-dimethyl-1,3-propanediol diacrylate), or combinations thereof, and wherein the ZrO₂ nanoparticle is present in an amount ranging from about 1% wt/v to about 80% wt/v.

27. The composition of claim 26, wherein the ZrO₂ nanoparticle is functionalized with at least one silane ligand.

28. The composition of claim 27, wherein the at least one silane ligand is selected from 3-acryloxypropyl-trimethoxysilane, 3-aminopropyl-trimethoxy silane, 3-aminopropyl triethyoxysilane, [methoxy(triethyleneoxy)propyl]trimethoxysilane, [methoxy(triethyleneoxy)propyl]triethyoxysilane, [methoxy(polyethyleneoxy)propyl]trimethoxysilane, [methoxy(polyethyleneoxy)propyl]triethoxysilane, 3-isocyanatopropyltrimethoxysilane, 3-isocyanatopropyltriethoxysilane, or a combination thereof.

29. The composition of claim 26, wherein the photoinitiator is selected from 1-hydroxy-cyclohexyl-phenyl ketone, benzophenone, 2,2-dimethoxy-1,2-diphenylethan-1-one, 1-[4-(2-hydroxyethoxy)-phenyl]-2-hydroxy-2-methyl-1-propane-1-one, 1-hydroxy-cyclohexyl-phenyl-ketone, 2-benzyl-2-dimethylamino-1-(4-morpholinophenyl)-butanone, bis(eta-5-2,4-cylcopentadien-1-yl)-bis(2,6-difluoro-3-(1H-pyrrol-1-yl)-phenyl) titanium, bis(2,4,6-trimethylbenzoyl)-phenylphosphineoxide, bis(2,6-dimethoxybenzoyl)-2,4,4-trimethyl pentylphosphineoxide, 2-hydroxy-2-methyl-1-phenyl-propan-1-one, 2-hydroxy-2-methyl-1-phenyl-propan-1-one-2,4,6-trimethylbenzoyldiphenyl-phosphine oxide, or combinations thereof.

30. The composition of claim 26, wherein the ZrO₂ nanoparticle has a diameter ranging from about 2 nm to about 50 nm.

31. The composition of claim 26, wherein the ZrO₂ nanoparticle is spherical, ellipsoidal, or oblate.

32. The composition of claim 29, wherein the monomer is selected from diethylene glycol diacrylate, neopentyl glycol diacrylate, or combinations thereof.

33. An apparatus, comprising:
a first ink jet head that produces droplets of a first composition, the first composition comprising a monomer selected from hexanediol-diacrylate, methyl acrylate, ethyl acrylate, butyl acrylate, isobutyl acrylate, n-hexyl acrylate, ethylhexyl acrylate, n-octyl acrylate, isobornyl acrylate, ethylene glycol monomethyl ether acrylate, diethyleneglycol monomethyl ether acrylate, triethylene glycol monomethyl ether acrylate, diethylene glycol diacrylate, triethylene glycol diacrylate, tetraethylene glycol diacrylate, neopentyl glycol diacrylate (2,2-dimethyl-1,3-propanediol diacrylate), or combinations thereof; and
a second ink jet head that produces droplets of a second composition, the second composition comprising a ZrO₂ nanoparticle and a monomer selected from hexanediol-diacrylate, methyl acrylate, ethyl acrylate, butyl acrylate, isobutyl acrylate, n-hexyl acrylate, ethylhexyl acrylate, n-octyl acrylate, isobornyl acrylate, ethylene glycol monomethyl ether acrylate, diethyleneglycol monomethyl ether acrylate, triethylene glycol monomethyl ether acrylate, diethylene glycol diacrylate, triethylene glycol diacrylate, tetraethylene glycol diacrylate, neopentyl glycol diacrylate (2,2-dimethyl-1,3-propanediol diacrylate), or combinations thereof.

34. The apparatus of claim 33, wherein the first composition further comprises a ZrO₂ nanoparticle.

35. The apparatus of claim 33, wherein at least one of the first composition or the second composition comprises a ZrO₂ nanoparticle at a concentration ranging from about 1 wt/v % to about 80 wt/v %.

36. The apparatus of claim 33, wherein the first ink jet head provides droplets of the first composition and the second jet head provides droplets of the second composition to a substrate at one or more selected locations, wherein the droplets of the first composition and the second composition have different sizes.

37. The apparatus of claim 33, wherein the first ink jet head provides droplets of the first composition and the second jet head provides droplets of the second composition to a substrate at one or more selected locations, wherein the droplets of the first composition and the second composition have the same size.

38. A method for making an optical element, comprising:
establishing a target surface and defining a target surface area based on a perimeter border;
directing droplets of a first composition comprising a monomer selected from hexanediol-diacrylate, methyl acrylate, ethyl acrylate, butyl acrylate, isobutyl acrylate, n-hexyl acrylate, ethylhexyl acrylate, n-octyl acrylate, isobornyl acrylate, ethylene glycol monomethyl ether acrylate, diethyleneglycol monomethyl ether acrylate, triethylene glycol monomethyl ether acrylate, diethylene glycol diacrylate, triethylene glycol diacrylate, tetraethylene glycol diacrylate, neopentyl glycol diacrylate (2,2-dimethyl-1,3-propanediol diacrylate), or combinations thereof toward the target surface so as to cover at least a portion of the target surface and the droplets have a predetermined refractive index distribution; and
directing droplets of a second composition comprising a monomer selected from hexanediol-diacrylate, methyl acrylate, ethyl acrylate, butyl acrylate, isobutyl acrylate, n-hexyl acrylate, ethylhexyl acrylate, n-octyl acrylate, isobornyl acrylate, ethylene glycol monomethyl ether acrylate, diethyleneglycol monomethyl ether acrylate, triethylene glycol monomethyl ether acrylate, diethylene glycol diacrylate, triethylene glycol diacrylate, tetraethylene glycol diacrylate, neopentyl glycol diacrylate (2,2-dimethyl-1,3-propanediol diacrylate), or combinations thereof toward the target surface, wherein at least one of the first composition or the second composition further comprises a ZrO₂ nanoparticle.

39. The method of claim 38, wherein the first composition has a first concentration and the second composition has a second concentration and the first concentration and the second concentration are different.

40. The method of claim 38, further comprising at least partially cross-linking the monomer of the first composition prior to deposition of the second composition.

41. The method of claim 38, wherein at least some of the droplets of the second composition contact at least some of the droplets of the first composition.

42. The method of claim 38, wherein at least some of the droplets of the first composition, and at least some of the droplets of the second composition contact the target surface.

43. The method of claim 38, further comprising exposing the droplets of the first composition and/or the droplets of the second composition to UV light so as to substantially crosslink the monomer.

44. The method of claim 38, wherein the monomer is diethylene glycol diacrylate, neopentyl glycol diacrylate, or a combination thereof.

45. The method of claim 38, wherein at least some of the droplets of the first composition or the second composition form at least one layer having a thickness ranging from at least 1 μm to about 10 μm.

46. The method of claim 38, wherein at least some of the droplets of the first composition or the second composition form at least one layer having a thickness ranging from at least 10 μm to about 30 μm

47. The method of claim 38, wherein at least some of the droplets of the first composition or the second composition have a volume of at least 0.5 picoliters to about 5 picoliters.

48. The method of claim 38, wherein at least some of the droplets of the first composition or the second composition have a volume of at least 1 femtoliter to about 125 picoliters.

49. The method of claim 38, wherein the first composition comprises the ZrO₂ nanoparticle and the monomer is selected from diethylene glycol diacrylate, neopentyl glycol diacrylate, or a combination thereof; the monomer of the second composition is selected from diethylene glycol diacrylate, neopentyl glycol diacrylate, or combinations thereof; and the method further comprises at least partially cross-linking the monomer of the first composition prior to deposition of the second composition.
